(19) United States
(12) Patent Application Publication
(10) Pub. No.: US 2009/0212593 A1
(43) Pub. Date: Aug. 27, 2009

(54) Accessories to equip and to control the interior environment for vehicle camping

(76) Inventor: Donald Leroy Larson, Colorado Springs, CO (US)

Correspondence Address: Donald L. Larson, 9615 Tall Trees Dr, Colorado Springs, CO, 80920, US

(21) Appl. No.: 12/070,878

(22) Filed: Feb. 21, 2008

(51) Int. Cl. B60P 3/363

(52) U.S. Cl. 296/158

(57) ABSTRACT

A method of equipping a vehicle (10), of the sports utility vehicle, van, or minivan type, with accessories which enables 2 adults to camp in the vehicle. This invention includes equipping vehicles designs that have been manufactured for several years as well as future new designs wherein several features can be designed into the vehicles to make ventilation (86) that is rain and insect proof, provide window covers (58, 60, 62, 64) for total privacy that can be easily installed and removed, as well as interface panel designs (252, 254, 256) that make connecting to external appliances easier and more robust. Bathing (18-24, 274, 286) and cooking with electric appliances on dash-mounted shelf (306) are also functions addressed. All accessories can be installed and removed quickly and do not permanently modify the vehicle.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention details accessories to provide camping functions in a van, minivan, or sports utility vehicle.

The present camping accommodations in vehicles range from large motor homes to conversion vans and the VW campers. All these vehicles have been around for years. They are expensive and generally not used as much for daily transportation as are vans, minivans, and sports utility vehicles. Vans, minivans, and sports utility vehicles are collectively referred to as vehicles in this patent application. Motor homes are generally parked or stored until used for a trip. Conversion vans have extensive and expensive modifications to the original vehicle designs. Compared to vans, minivans, and sports utility vehicles, conversion vans are heavier, less fuel efficient, and generally have more restrictions on the visibility out of the windows when driving. Conversion vans interiors have traditionally deteriorated and resulted in a more rapid depreciation of the vehicle value when compared to a regular vans, minivans, and sports utility vehicles. Vans, minivans, and sports utility vehicles typically have cargo area seats that fold back and provide a cushioned sleeping surface or can be removed and a mattress can be inserted for sleeping.

2. Description of the Prior Art

In order to sleep or bath in a vehicle the windows must be totally covered to prevent people outside the vehicle from peeking around any open spaces around the edges of smaller window coverings. U.S. Pat. No. 4,815,784 (1989) of Zheng is called a “sunshield” and sufficiently blocks most of the sun from entering the vehicle but does not make the windows peek-proof by provide total coverage of the windows. The same is true for U.S. Pat. No. 6,044,891 by Guo and Des. 400,039 by Wolgan as well as U.S. Pat. No. 5,024,262 by Huang. U.S. Pat. No. 2002/0108324A1 by Maynard does provide for total coverage but is applied to the exterior of the windows and has the disadvantage of allowing the covering to be lifted and peeking to occur as well actual theft of the coverings themselves. Whereas, U.S. Pat. No. 4,790,591 is on the window interior, it requires a preferred hook and loop fastening system. This has the disadvantage of modifying the vehicle by requiring the permanent attachment of either the hook or loop part of the fastener pair to be placed on the window or the window moldings. U.S. Pat. No. 5,806,906 by Hammond is typical of numerous patents that attach a portion of a tent or and entire tent to a vehicle opening. Hammond calls this both a “camping enclosure” and also a “tent enclosure.” The applicant's invention does not include camping or tent enclosures. U.S. Pat. No. 5,678,882 by Hammond has the title of “enclosures and accessories for sport utility vehicles, vans and minivans.” Here again, a good portion of the patent is devoted to tent-like “enclosures.” The “accessories” covered by Hammond include several embodiments of a “ventilation window”. One embodiment is the ventilation window that fits in the vehicle's window glass grooves when the window glass is rolled down inside the bottom portion of the vehicle door. There is a water proof flap that can be secured down to keep out the rain while covering an insect-proof screen, but the flap can be rolled up for ventilation. The applicant's invention allow for ventilation during a rain as a hood is provided and the structure is much more robust to keep out animals and humans. This design's adapter is much stiffer and has clamps to make it much more difficult for a person to remove the adapter from the outside. Further, the applicant's invention allows for both natural ventilation as well as forced ventilation by means of a fan while Hammond's invention only provides natural ventilation. Hammond's invention covers numerous ways to have a ventilation window installed in the vehicle's louvered windows. In all cases the water seal providing protection from the rain is made by using the original window seal that is part of the vehicle. Various methods are used to hold or press Hammond's ventilation window insert against the vehicle's original window's seal or gasket. The applicant's invention does not use the vehicle's original window seal but provides a different seal that makes for easier installation and removal. Several other embodiments of Hammond's ventilation window consists of a “wedge shaped rigid box” with screening material over the ventilation holes in the box. The applicant's invention has a much simpler embodiment that does the same function as Hammond's wedge shaped rigid box. The applicant's simpler embodiment consists of a commercially available rubber “flap seal” that fastens to the edge of the open louvered window glass and has screen covering the holes made on the bottom edge of the flap.

Hammond's invention's accessories only provide camping functions of being able to sit or sleep out of the weather and protected from insects. Hammond's invention's accessories allow for ventilation if the wind is blowing. The applicant's invention provides force ventilation without any wind as well as many more functions as will be discussed in later prior art discussions.

U.S. Pat. No. 4,295,678 by Morris describes a structure that is added on to the rear of the vehicle and then discusses what can be added to the structure. He calls the additions “desired camping facilities.” He lists: sinks, bunks, countertops, cabinets, and even toilet facilities. Morris then says none of the prior art he lists is completely satisfactory because of the excessive amount of work necessary to make the conversions. However, Morris's invention also requires an excessive amount of work to make the conversion when compared to the applicant's invention.

U.S. Pat. No. 7,172,231 by Johnson II claims a countertop, sink, stove, and adds a water heater for, presumably, cooking, and the washing of dishes, food, and hands. All of these facilities are added to a trailer rather than a motor vehicle. Johnson II's prior art gives extensive discussions of facilities added to other trailers too.

U.S. Pat. No. 4,969,678 by Loisel describes and claims the following camping accessories: bed, sliding table, sink, gas stove, and water tank, all containable in a box which is heavy and awkward to handle and store when out of the vehicle. The gas stove cannot be operated in the closed vehicle because of the possibility of carbon monoxide poisoning. By contrast, the applicant's invention has all gas burning appliances located outside the vehicle and the medium that the appliance either heats or cools is ducted into the vehicle interior. The medium can be with a liquid or air. The applicant's invention only recommends electric appliances be operated inside a vehicle when placed upon the “dash-mounted shelf ” which functions like a table or a countertop and can be used to hold appliances like an electric skittle, grill, popcorn popper, microwave, etc. The dash-mounted shelf can also for purposes other than cooking. Loisel never mentions privacy, but does show curtains only on the side of the vehicle in his FIG. 8.

Unlike the applicant's invention, none of the above prior art inventions provides accessories for vehicle's interior comfort with the vehicle motor turned off. That is, there is not interior heating, air conditioning, forced ventilation, or bathing apparatuses. Most of the above prior art does not provide the accessories for privacy that is necessary for bathing. The applicant's invention uses accessories that are called “adapters”. These adapters allow pipes, hoses, or ducts to pass though normal vehicle openings such as windows or tailgates while keeping out rain, insects, and animals. The pipes, hoses, or ducts conduct the medium in and out of the vehicle. The medium can be a liquid or air that has been either heated or cooled by a commercially available appliance. All of the camping functions in the applicant's invention has been prototyped and documented with the USPTO's Document Disclosure Program before the Document Disclosure Program was terminated in 2007.

### OBJECTS AND ADVANTAGES

Several objects and advantages of the present invention are it:
(a) Allows 2 adults to camp in the very popular vans, minivans, and sports utility vehicles.
(b) Costs a fraction of the normal costs of a conversion van.
(c) No permanent major modifications to the vehicle are required which would cause an increase in depreciation.
(d) Modification and accessory appliances are inexpensive.
(e) Changing between the camping configuration and the travel configuration can be made in minutes.
(f) Clothing, sleeping, and other camping or travel equipment can be stored in vehicle.
(g) Most equipment added by this invention can be stored in the vehicle when traveling, or easily removed and stored else where.
(h) In the event of emergency evacuations two adults can camp in the vehicle and with one of the commercially available tents the attach to the tailgate that number can be increased.
(i) Design ideas can be incorporated into the future designs of vans, minivans, and sports utility vehicles.

### SUMMARY OF THE INVENTION

Accordingly, it is an object of the present invention to provide additional functionality for vehicles of the sports utility vehicle, van, or minivan type to temporarily add accessories that will allow bathing in the vehicle.

Another object of the present invention is to provide total privacy with the addition of simple accessories.

Another object of the present invention is to provide ports to allow externally mounted appliances to heat or cool the interior of the vehicle without the vehicle motor running.

A further object of the present invention is to allow natural ventilation while keeping out rain, insects, and small animals.

A further object of the present invention is to provide forced ventilation with the aid of a battery operated fan so as to not run down the vehicle battery, while keeping out rain, insects, and small animals.

A still further object of the present invention is to describe the use of all bathing accessories to be used completely separate from the vehicle to allow bathing in emergency situations

A still further object of the present invention is to enable cooking with electric appliances in the vehicle.

The above objects and others are realized in accordance with the present invention by accessories which are added to a sports utility, van, and minivan type vehicle.

### BRIEF DESCRIPTION OF THE DRAWINGS

Other objects, advantages, and features of the present invention will be more apparent from the following detailed description when taken with the drawings in which:

FIG. 1 is a partial side view of the exterior of a sports utility vehicle, minivan, and van, vehicle with the sliding door shown in the open position;

FIG. 2 is a perspective view of a typical window covering that provides privacy;

FIG. 3 shows the details of stapling the vinyl;

FIG. 4 is the inside view of a typical rear window with 2 overlapping covers;

FIG. 5 is a close up detail of rear window with an electronic actuator;

FIG. 6 shows the window covering completely installed in rear window;

FIG. 7 shows a natural ventilation adapter;

FIG. 8 shows the details of the flap seal;

FIG. 9 shows the screening material;

FIG. 10 shows a bulb seal modified by using scissors;

FIG. 11 is a view from behind the rear edge of an open louvered window;

FIG. 12 shows the ventilation adapter bulb seal with the vehicle window in the closed position;

FIGS. 13 and 14 are not used;

FIG. 14 is a side view of the vehicle provided with a unfolded bed platform and the front panel raised to allow access to the front storage container;

FIG. 15 shows the screening material;

FIG. 16 show a rain hood;

FIG. 17 is not used;

FIG. 18 is a view inside the vehicle and shows a fan;

FIGS. 19 thru 34 are not used;

FIG. 35 shows a port adapter with access door;

FIG. 36 is an inside view of an adapter used as ventilation adapter and also a port adapter;

FIG. 37 is a detail drawing describing the hinge of a door;

FIG. 38 shows a storage container used as a tub;

FIG. 39 shows how the splash guard is attached to the tub;

FIG. 40 shows a dash-mounted shelf,

FIG. 41 shows the bottom view the dash mounted shelf removed from the vehicle;

FIG. 42 shows 4 options for Section A-A of FIG. 11;

FIG. 43 shows the top portion of the rear of the vehicle and illustrates another alternative embodiment of a ventilation adapter;

FIG. 44 shows a collapsible rain hood on a window ventilation adapter;

FIG. 45 shows an alternative embodiment of ventilation adapter that fits into a louvered window;

FIG. 46 is a common brass “L” bracket;

FIG. 47 is an outside view of the upper right hand corner of a ventilation adapter;

FIG. 48 is a view of the rear edge of the adapter in FIG. 45;

FIG. 49 shows the lever in the partially closed position;

FIG. 50 show the lever all the way closed;

FIG. 51 shows the fan and the battery pack attached to the adapter;

FIG. 52 is a view outside the vehicle from below the rear edge of the vehicle window;

FIG. 53 shows a simple window adapter that provides 2 ports for flexible tubing;

FIG. 54 shows the window adapter from the previous FIG. 53 removed and inverted to show the construction details;

FIG. 55 is another example of a port adapter used for ducting;

FIG. 56 shows ventilation adapter in a louvered window;

FIG. 57 shows yet another method of providing ports which is in the tailgate adapter;

FIG. 58 shows another method of supplying ports to a vehicle without adding window or tailgate opening adapters;

FIG. 59 shows a portable enclosure that mounts on top of a vehicle;

FIG. 60 shows hot water heating appliance mounted on the roof but not in an enclosure like FIG. 59.

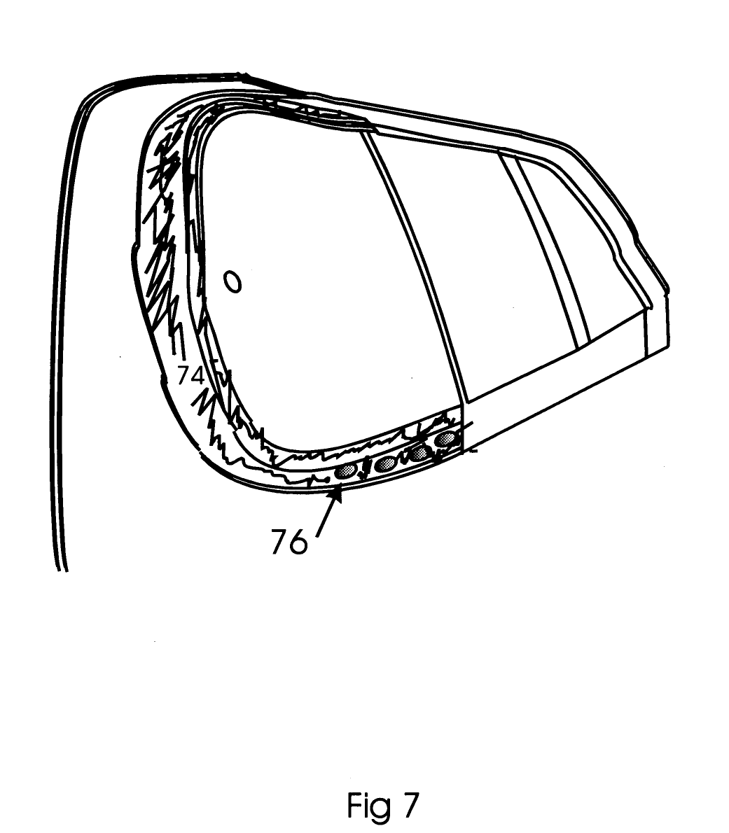

### REFERENCE NUMERALS

| | |
|---|---|
| 10 | Vehicle |
| 12 | Passenger side front door |
| 14 | Passenger side sliding door |
| 16 | Tailgate window |
| 18 | Tub for bathing |
| 20 | Flexible splash guard |
| 22 | Flexible splash guard |
| 24 | Flexible splash guard |
| 26 | Passenger side front door |
| | window |
| 28 | Passenger side sliding door |
| | window |
| 37 | Push-on channel clamp at |
| | both ends |
| 38 | Push-on channel clamp at |
| | vehicle body end |
| 39 | Manufacturer's adhesive on |
| | window |
| 40 | Manufacturer's adhesive at |
| | both ends |
| 45 | Screen |
| 46 | Letter holder |
| 47 | Loop fastener |
| 48 | Hook fastener |
| 50 | Window cover core |
| 52 | Vinyl covering |
| 54 | Staple |
| 56 | Stapler |
| 58 | Left rear window covering |
| 60 | Right rear window covering |
| 62 | Left side rear window |
| | covering |
| 64 | Right side rear window |
| | covering |
| 66 | Right side rear window glass |
| 68 | Electronic actuator |
| 70 | Grove cut in body |
| 72 | Folded and stapled vinyk |
| 74 | Dense flap seal |
| 76 | Ventilation Holes |
| 78 | Flap metal insert located in |
| | the push-on clamp channel |
| 80 | Needle nosed pliers |
| 82 | Screen |
| 84 | Rubber Glue |
| 86 | Bulb seal |
| 88 | Scissors |
| 90 | Push-on clamp channel |
| 92 | cut line |
| 94 | Vehicle window |
| 96 | Vehicle window actuator |
| 98 | Window seal |
| 100 | Rubber cement or glue |
| 102 | Vehicle body |
| 150 | Vehicle top |
| 152 | Vehicle rear window |
| 154 | Vehicle louvered window |
| 156 | Collapsible with ventilation |
| | via overlapping curtain on |
| | the rear edge in addition to |
| | the bottom |
| 158 | Plastic or metal screening |
| | material |
| 160 | Rigid screen - letter holder |
| 162 | Rain hood - rigid |
| 166 | Window Adaptor |
| 168 | Collapsible rain hood |
| 170 | Rectangular plastic support |
| 172 | Shelf hinge |
| 174 | Fan |
| 176 | Fan battery pack |
| 178 | Steering Wheel |
| 180 | One of 4 levers to hold |
| | adapters against the outside |
| | of the drivers window |
| | opening with glass moved |
| | down inside the door |
| 182 | Window adapter |
| 184 | Hole for mounting fan with |
| | screen visible |
| 186 | Bolt heads |
| 188 | Loop fastener |
| 200 | Lever to engage window |
| | latch |
| 202 | Window latch engaging port |
| 203 | Vinyl |
| 204 | Brass “L”bracket modified |
| 206 | 1^{st} bend “L” bracket |
| 208 | 2^{nd} bend “L” bracket |
| 210 | Bolt holes |
| 212 | Seat belt clip |
| 214 | Lever |
| 216 | Rear edge of window adapter |
| 217 | Staple |
| 218 | Hook fastener |
| 220 | Loop fastener |
| 221 | “L” bracket modified |
| 222 | Window latch |
| 224 | Fan |
| 225 | Loop fastener |
| 226 | Battery pack |
| 228 | Vehicle window edge |
| 230 | Vinyl |
| 231 | Closed louvered window |
| | behind open window 228 |
| 232 | Screen |
| 234 | Window adapter with ports |
| 236 | Window adapter pieces |
| 238 | Window adapter grove |
| 239 | Flexible ducting |
| 240 | Tailgate adapters |
| 242 | Portable A/C |
| 244 | A/C output manifold |
| 246 | A/C output manifold ducting |
| 248 | Hitch mounted carrier |
| 250 | A/C return manifolds |
| 251 | Air port connector |
| 252 | Body mounted ports |
| 253 | Liquid port connector |
| 254 | Body mounted ports ½ |
| 255 | Electrical connector |
| 256 | Body mounted ports ½ |
| 258 | Roof top carrier |
| 260 | LP Gas bottle |
| 262 | Gas hot water heater |
| 264 | Coleman ™ Hot water heater |
| 265 | Coleman ™ Hot water heater |
| | hose |
| 266 | Dense flap seal of FIG. 7 |
| 268 | Dense flap seal holes |
| 270 | Window adapter |
| 272 | Window Adapter Access door |
| 274 | Hot water hose |
| 276 | Storage container used as a |
| | spacer |
| 278 | 3 step collapsible stool |
| 280 | Hot water heater control and |
| | indicators |
| 281 | Access door for 110VAC |
| | power cord |
| 282 | Human hand and arm |
| 286 | Hot water shower head |
| 288 | Uncut plastic |
| 289 | Cut line |
| 290 | Cut plastic |
| 291 | Plastic hinge |
| 292 | Storage container |
| 294 | Step stool used as seat for |
| | bather |
| 302 | Loop part of hook and loop |
| | fastener |
| 304 | Hook part of hook and loop |
| | fastener |
| 306 | Dash mounted table top |
| 308 | Wedge to hold anchor peg into |
| | window defroster grill |
| 309 | Vehicle seat |
| 310 | Leveling block |
| 312 | Upper shelf |
| 314 | Shelf leg |
| 316 | Angle iron |
| 318 | Rubber hose |
| 320 | Vehicle windshield |
| 322 | Shelf leg mounting bracket |
| 326 | Optional adjustment button |
| 328 | Anchor peg |
| 332 | Steering wheel |

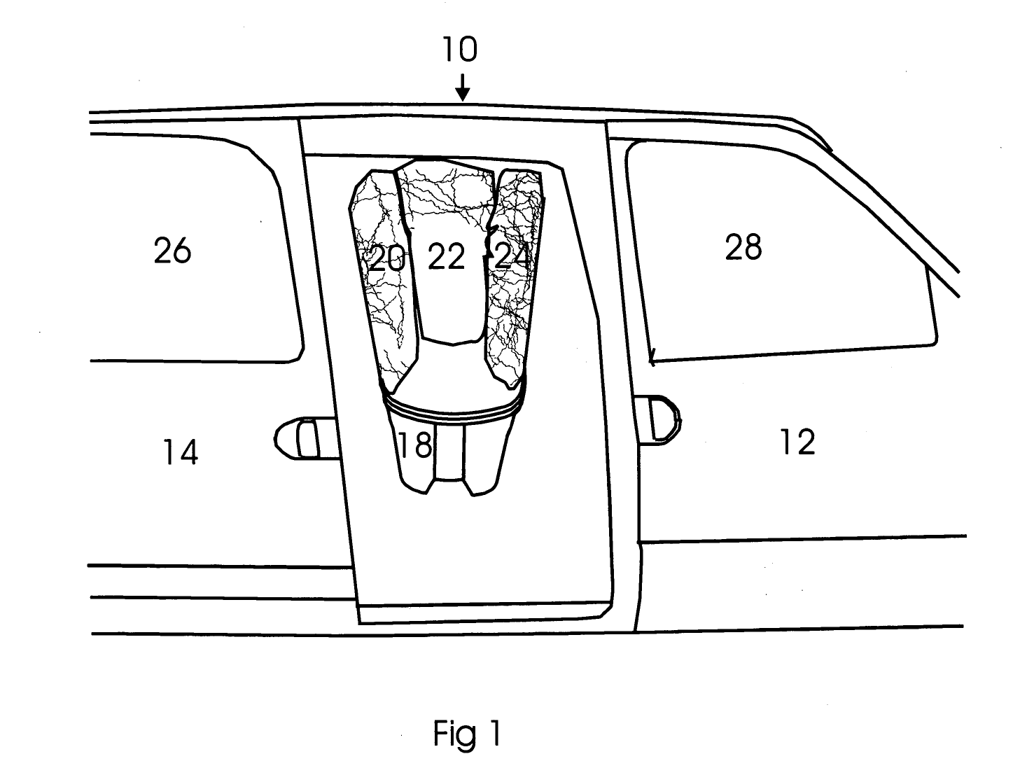

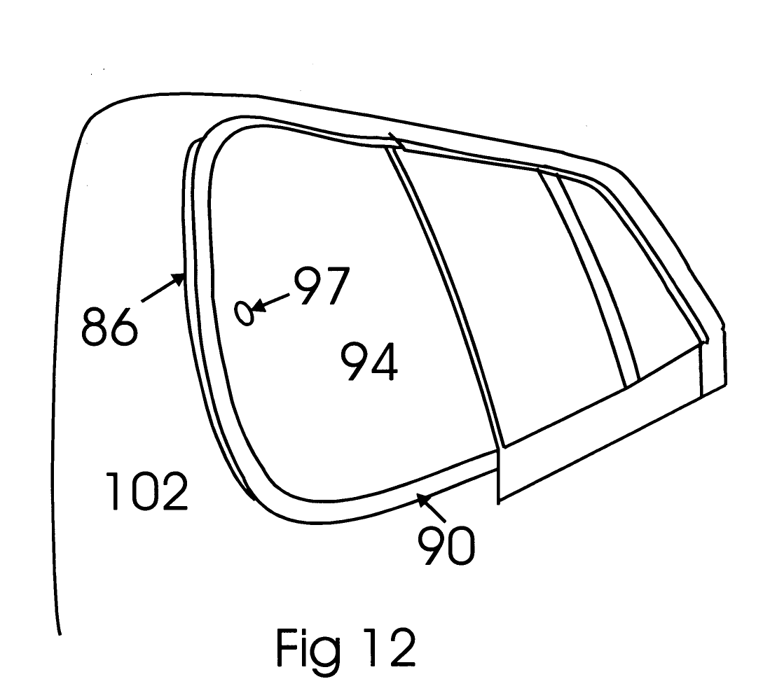

### FIGS. 1-41—Preferred Embodiment

Referring now to the figures wherein the showings are for purposes of illustrating the preferred embodiment of the invention only and not for purposes of limiting the same, FIG. 1 shows a vehicle 10 of the sports utility vehicle, minivan, and van types with a driver's seat and front passenger's seat and a cargo carrying area behind those two seats. In the cargo carrying area there is sufficient room to sleep on a mattress as well as other camping functions that will be more fully explained below. All the equipment that is added to provide camping functions described below can be used independently or in any combinations with any other equipment described below.

The best mode for carrying out the invention will now be described for the purpose of illustrating the best mode known to the applicant at the time. The examples are illustrative only and not meant to limit the invention as measured by the scope and spirit of the claims.

In FIG. 1, a portion of the passenger side of vehicle 10 is shown. As is typical with vehicles of these types, a passenger's door 12 has a sliding door 14 behind it that allows access to the cargo carrying area. Sliding door 14 is shown in the open position in FIG. 1. Through the open door a storage container 18, and splash guards 20, 22, and 24 can be seen that have been inserted in the cargo carrying area for the purpose of bathing. Storage container 18, and splash guards 20, 22 and 24 are an example of accessories that this invention provides to a vehicle to equip it for vehicle camping and will be described in detail later. For normal bathing usage the sliding door 14 would be closed and several other accessories would be used. In addition to the doors being closed, the window covers would be in place, ventilation adapters would be used to exchange humid interior air for outside air, and a port adapter would be used to allow a hand to adjust the temperature controls on an externally mounted hot water heater. All of these accessories will be described in detail in later paragraphs.

As is typical with vehicles of these types there are two types of windows that can be opened for ventilation. Sliding door 14 has a window 26 that is of the louvered type that is hinged at the front edge with a vertical hinge and opens at the rear edge with an actuator the can be manual or powered electronically. Passenger door 12 has a window glass 28 that retracts down into a area inside the lower part of door 12. This invention provides adapters for both types of windows for the purposes of allowing both natural and force ventilation as well as port adapters that allow hoses and flexible ducting to enter the vehicle while providing protection from rain, insects and small animals. As alluded to hereinbefore, inasmuch as the vehicles of this type presently manufactured are primarily intended for transporting passengers from one location to another, this invention expands the utility and allows the vehicle to be used for other camping functions to be described in the following figures.

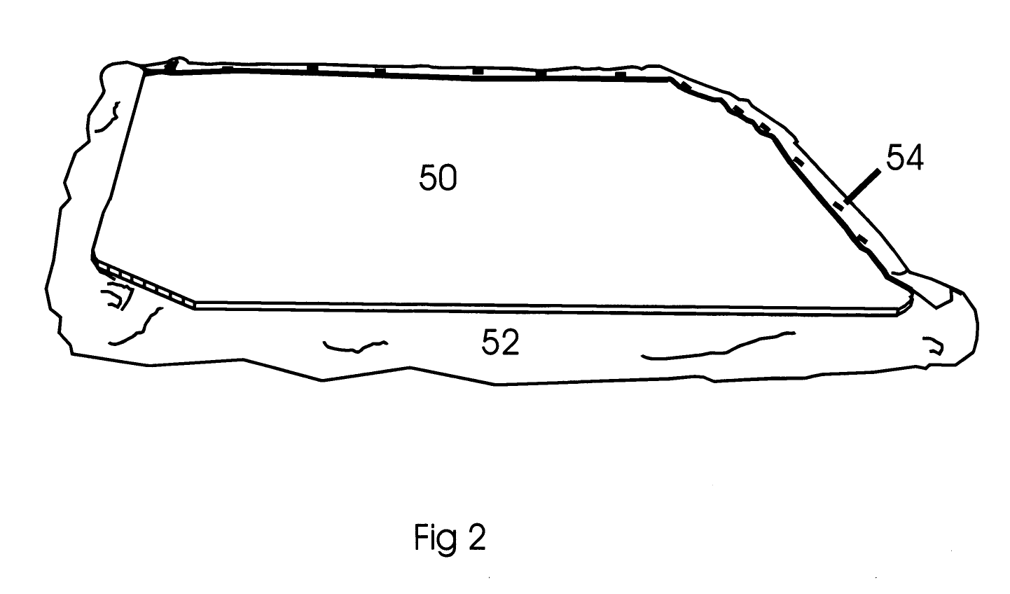

Many camping functions such as bathing or sleeping have a need for privacy. FIG. 2 shows a typical window covering that provides privacy. The main component 50 is a sheet of 6mm twin wall polycarbonate material. This component is cut to fit the inside edge of the vehicle window's frame. Vinyl material 52 is placed over the outside surface of the main component 50 and cut 3 inches to 4 inches larger around all edges. Staples 54 are used to attach the vinyl to the main component 50.

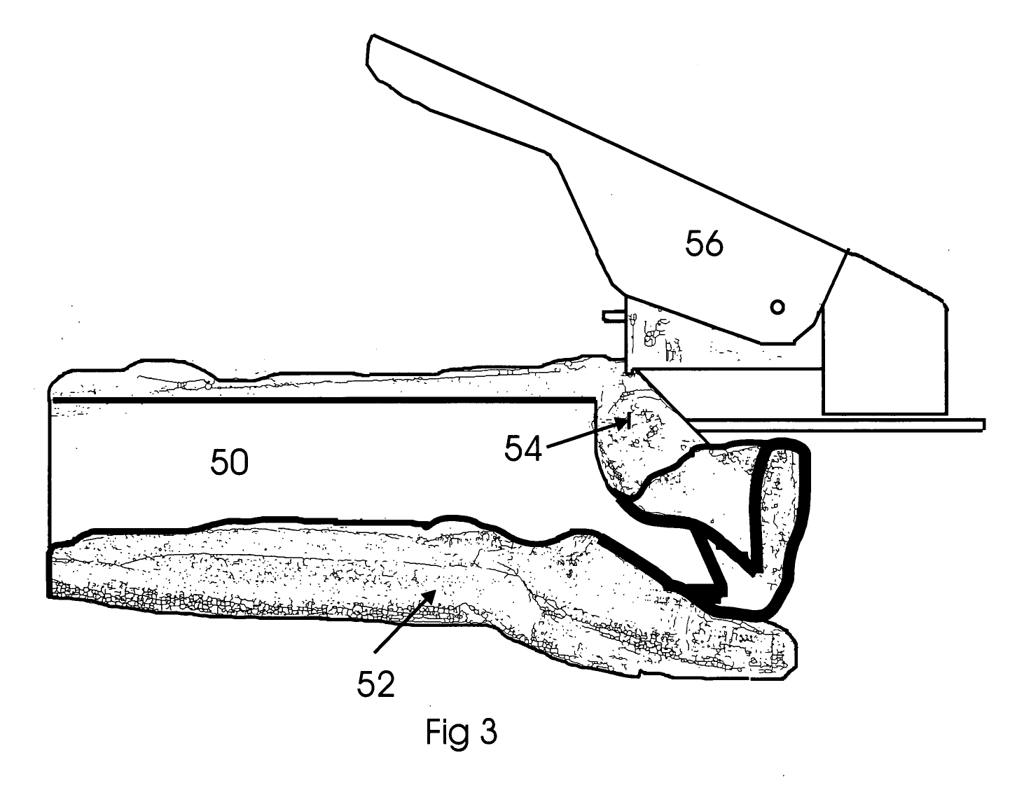

FIG. 3 shows the details of stapling the vinyl. The excess vinyl is folded under such that it provides approximately a one inch seal 52 around the entire main component 50. The large stapler 56 provides the staples.

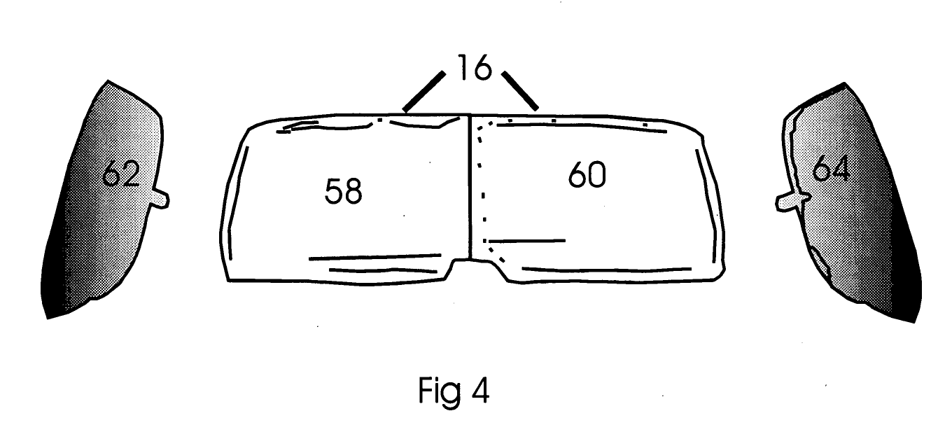

In the center of FIG. 4 is the inside view of a typical rear window 16 with 2 overlapping covers 58 and 60. The windshield (not shown) also requires overlapping covers. All other windows have a single cover such as rear window covers 62 & 64.

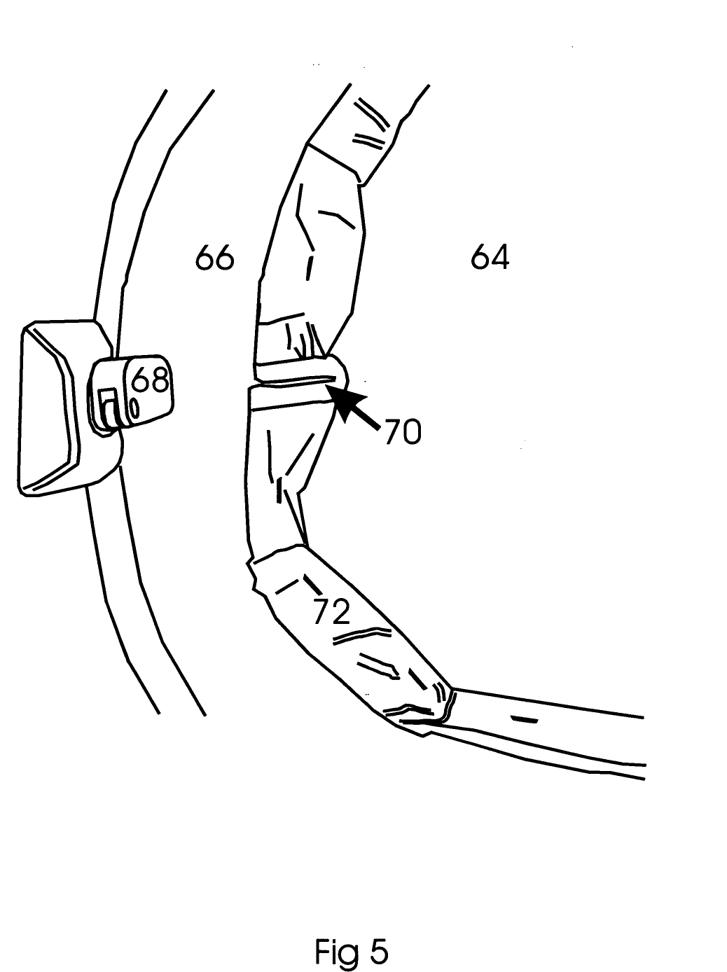

FIG. 5 is a close up detail of rear window 66 with an electronic actuator 68 that is part of the vehicle. The window covering body 64 has a grove 70 cut in the body 64 and in the vinyl 72 to allow it to be slipped to the left behind the actuator 68.

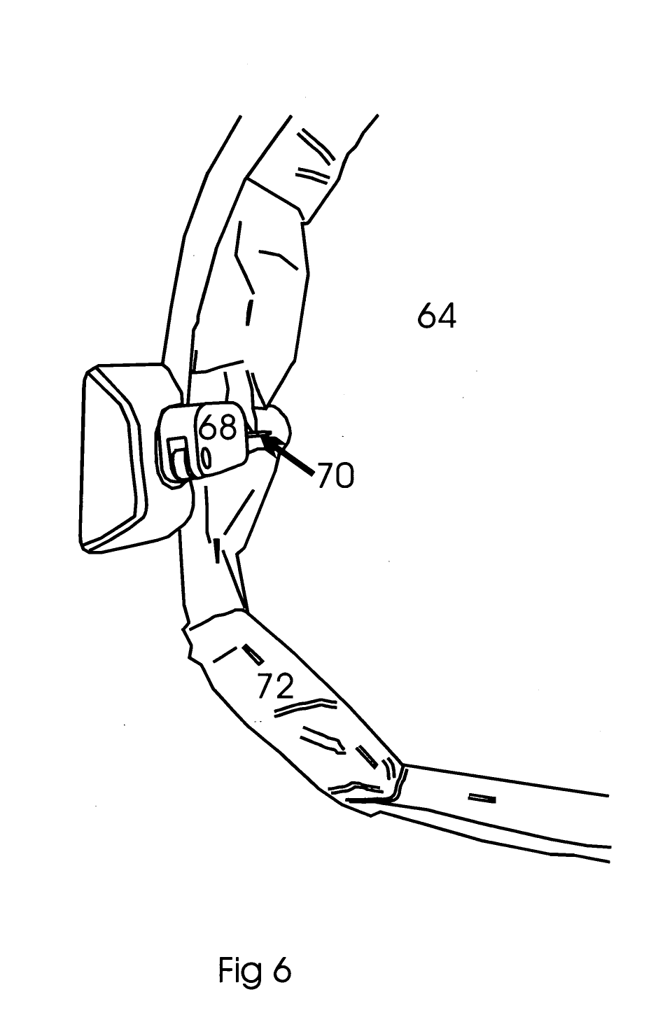

FIG. 6 shows the window covering body 64 completely installed in rear window 66 and blocks the entire window 66 to provide total privacy. The excess vinyl from the stapling described in FIG. 3 provides a seal 72 that provides a perfect privacy by filling the void that may be created where the body 64 does not make a perfect fit to the window border. These window covers are held in place by friction fit to the vehicles interior plastic parts that form a molding around each window. Seal 72 helps make the friction for the fit.

FIG. 7 shows a natural ventilation adapter 74 that is very simple but also rigid so it will not allow the window to close. This adapter should be installed on louvered windows that are to remain open. It is made from Uni-grip part number ED-5335 dense-flap seal 74. The 4 ventilation holes 76 are shown on the bottom. The holes are covered with screening material which is glued to the seal. Holes can be any shape including round. The flap is cut to fit around the 3 sides of the window that are open as shown in FIG. 7.

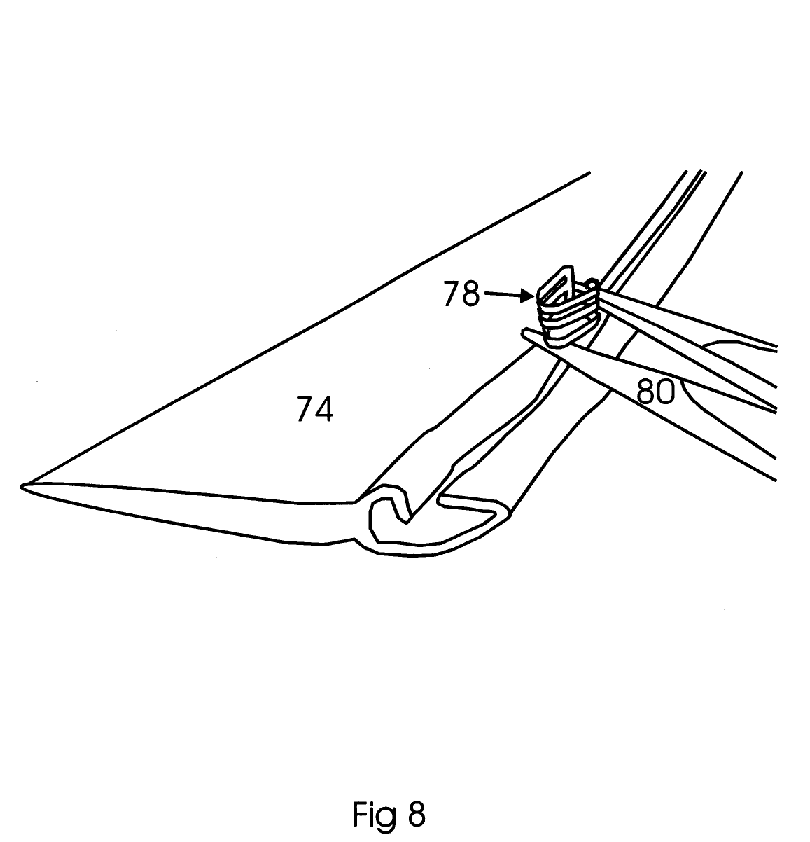

FIG. 8 shows the details of the flap seal 74. Each end must be modified by having the metal insert 78 removed from the last 4-6 inches from each end. This is easily done with a needle nosed pliers 80.

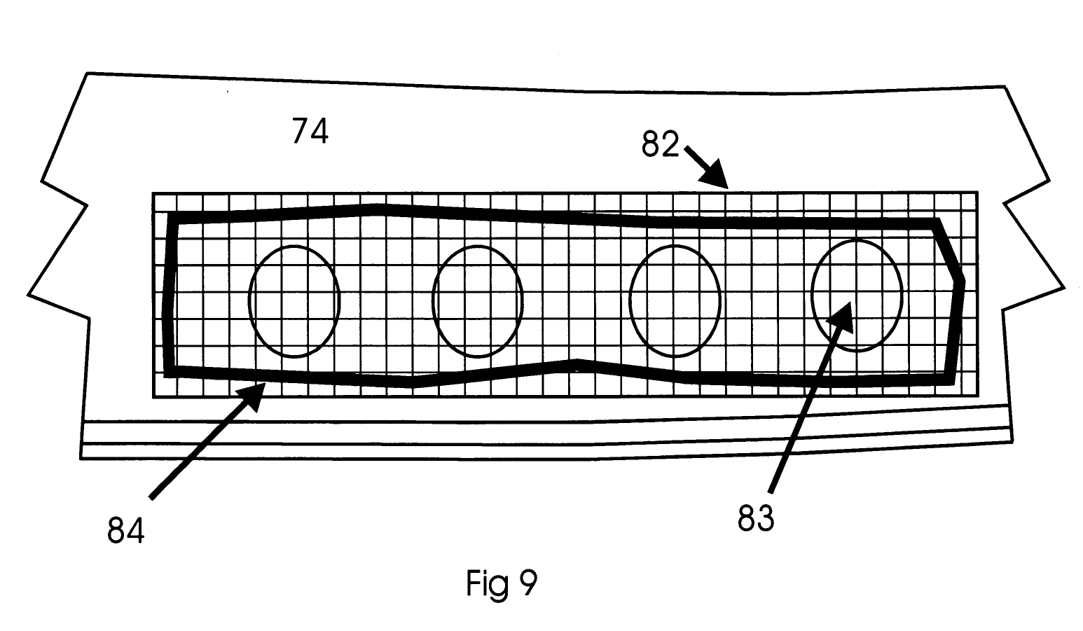

FIG. 9 shows the screening material 82 cut to cover the four holes 83 being on typical hole. Any plastic or screening material may be used. Attach to 74 with a rubber glue 84 around the screen edges.

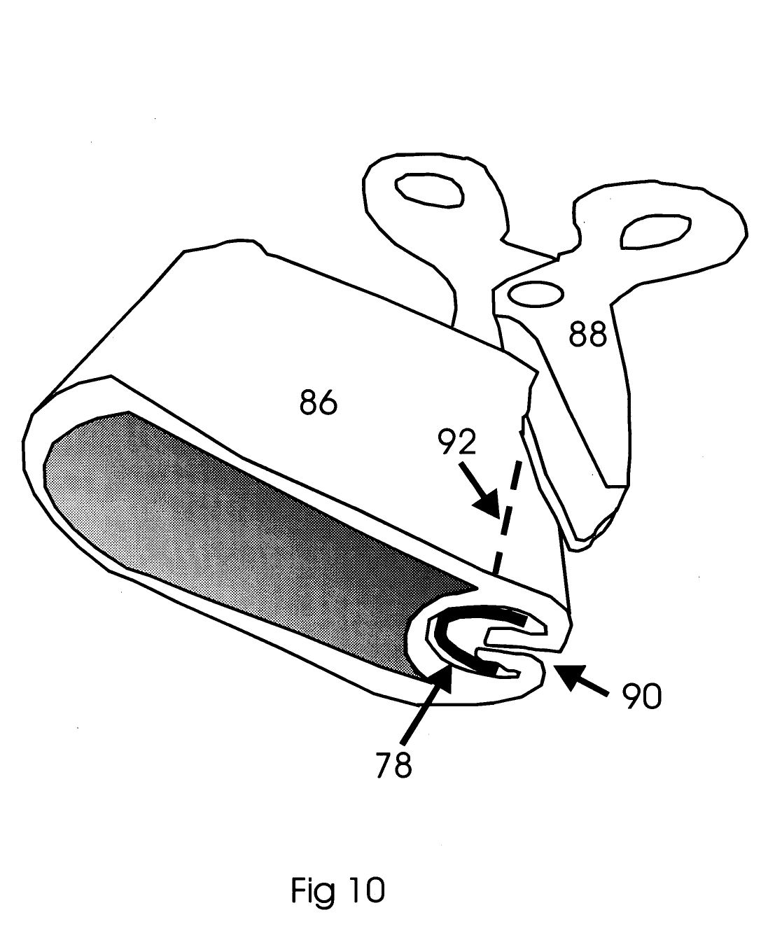

FIG. 10 shows is Uni-grip Inc 9823 St, Rt 53N Upper Sandusky, Ohio 43351 part number SD-170 bulb seal 86 modified by using scissors 88 to cut one side of the rubber bulb 86 where it meets the push-on channel clamp 90. The cut will be along the dashed line 92. The metal portion of the push-on channel clamp is the same as item 78 shown in FIG. 8 that has not been removed.

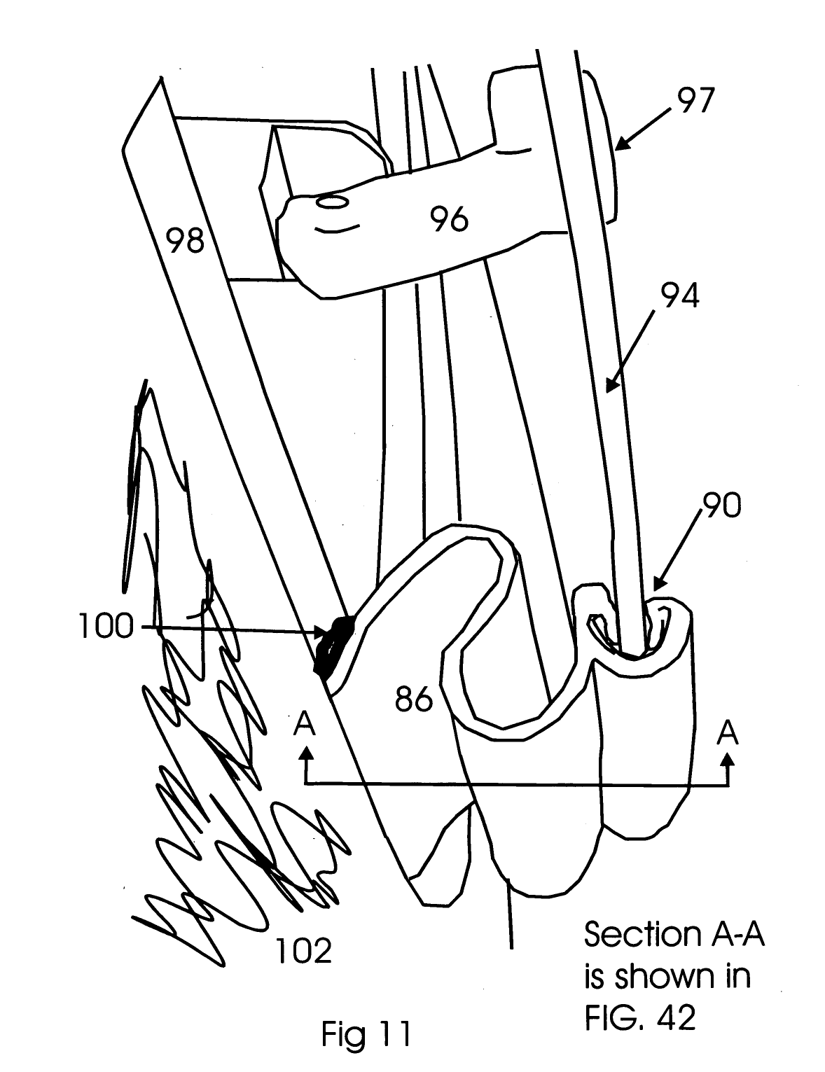

FIG. 11 is a view from behind the rear edge of an open louvered window showing the electronic actuator 96. It also shows a cutaway portion of the modified SD-170 bulb seal 86 placed on the window edge 94 and the other end of the modified bulb seal attached to the existing vehicle window seal 98 with rubber cement 100. The push-on channel clamp portion of the bulb seal 90 goes over the window glass rear edge 94 as shown. Bulb seal 90 holds the adapter in place since it fits tightly over the window glass edge 94. Since bulb seal 86 is rigid, it is force against the vehicle body and make a water proof seal. Section A-A will be shown in FIG. 42 in a later section.

FIG. 12 shows the modified SD-170 ventilation adapter bulb seal 90 with the vehicle window 94 in the closed position. The electronic actuator has a mating nut-like part 97 that belongs to the vehicle as does the vehicle metal skin 102. In the closed position the bulk of the ventilation adapter 86 is stored inside the vehicle.

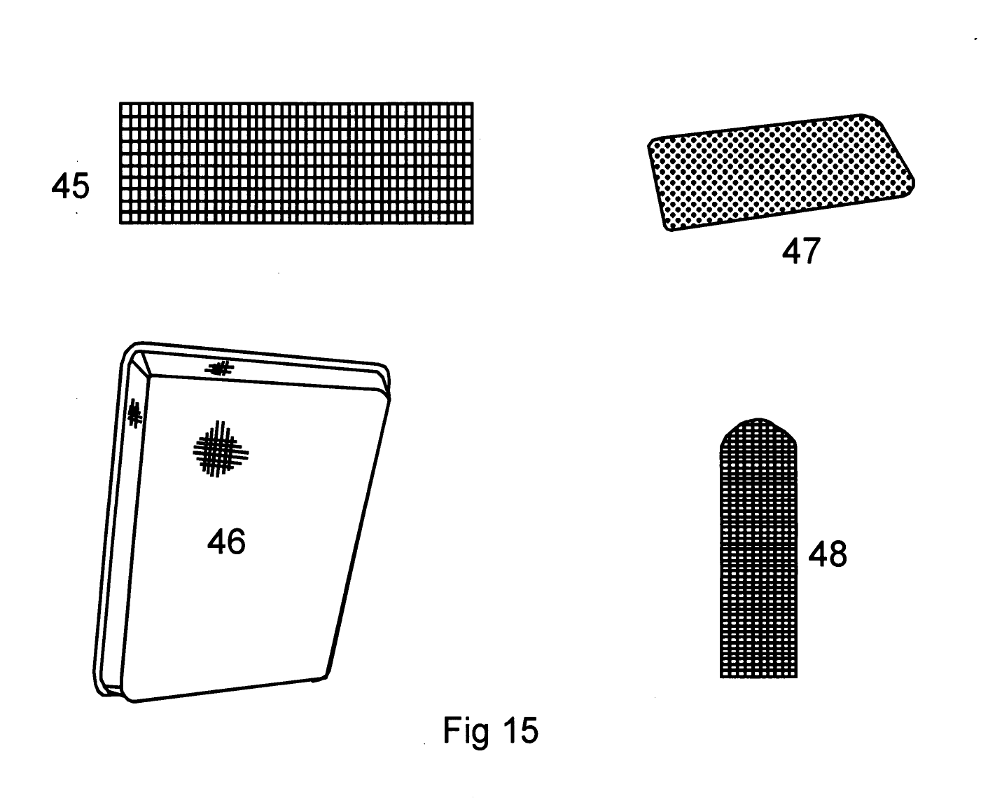

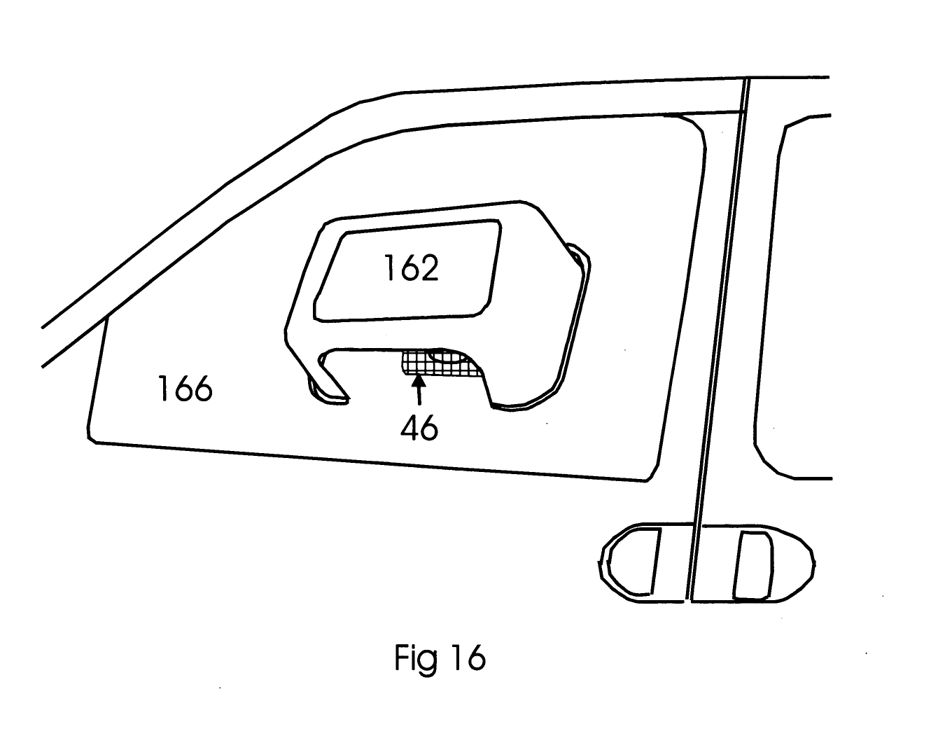

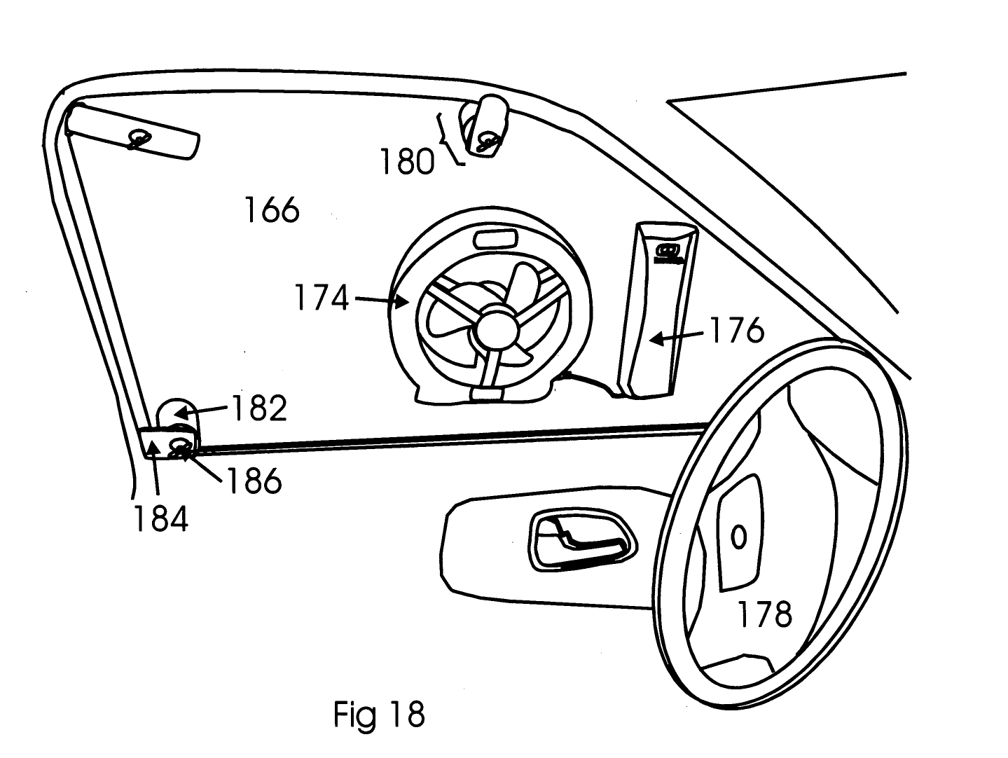

FIG. 15 shows the screening material 45 which is designed as 82 in FIG. 9 which is best for small holes and attached with rubber cement. Also shown in FIG. 15 is a rigid screen 46 that is preferable for larger holes to be shown next. Rigid screen 46 used here is a Mesh Letter Tray-Rubbermaid part number 46833DI sold by Walmart and is made from a black metal mesh. Whereas the screening material 45 can be attached by rubber cement, rigid screen 46 is preferred to be attached by #6 flat head sheet metal screws or a hook 47 and loop 48 fastener pair which is cut to needed size from a self adhesive commercially available product called “Velcro Industrial Strength” that is 2 inches wide and 4 feet long (no part number is listed on the package). The most common cut size is 1 inch by 2 inches with optional rounded corners as shown in FIG. 15. Hook 47 and loop 48 fastener pair is used on many other accessories to be described later in the invention. FIG. 16 show a rain hood 162 used to cover rigid screen 46 in FIG. 15, on window adapter 166 which will allow for forced ventilation such as shown in FIG. 18.

Up until now the description here has provided ventilation with ambient air. Ventilaion adapters have been shown that move ambient air by natural flow or the air can be forced by means of a fan. FIG. 18 is a view inside the vehicle and shows a fan 174 which provides forced ventilation. The fan shown is commercially available from Coleman Co. Both the fan and the battery pack 176 with switch is mounted to window adapter 166 using hook and loop fasteners. The adapter requires the window to be completely open before it is installed. It is held in place by 4 rotatable levers 180. The adapter is made out of 10 mm twin-wall polycarbonate material which is cut approximately 2 inches larger than the window opening to allow for a weather seal (not shown) to be applied between the window frame and the outer edge of the adapter. The 4 levers 180 are similar and in each corner of the window opening but only 3 are shown in FIG. 18. The levers are held in place by carriage bolts (not shown) and wing nuts 186. The levers are spaced away from the window adapter by 2 inch diameter plastic rod 182 cut to the proper length. The levers 184 themselves are plastic laminate ¼ inch thick and approximately 2 inches by 4 inches.

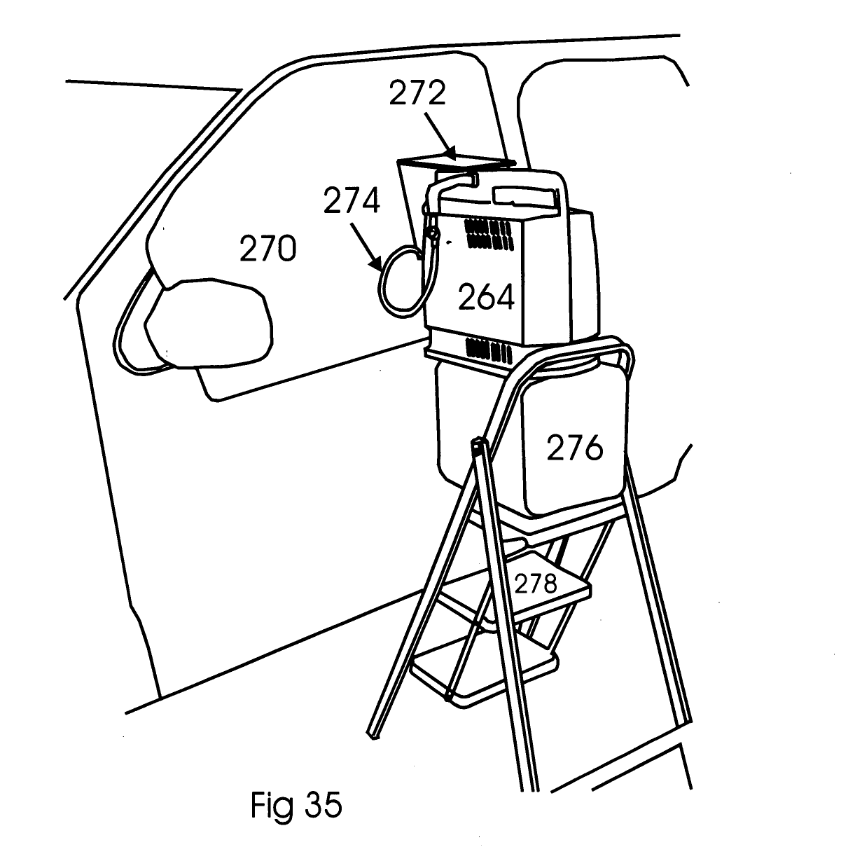

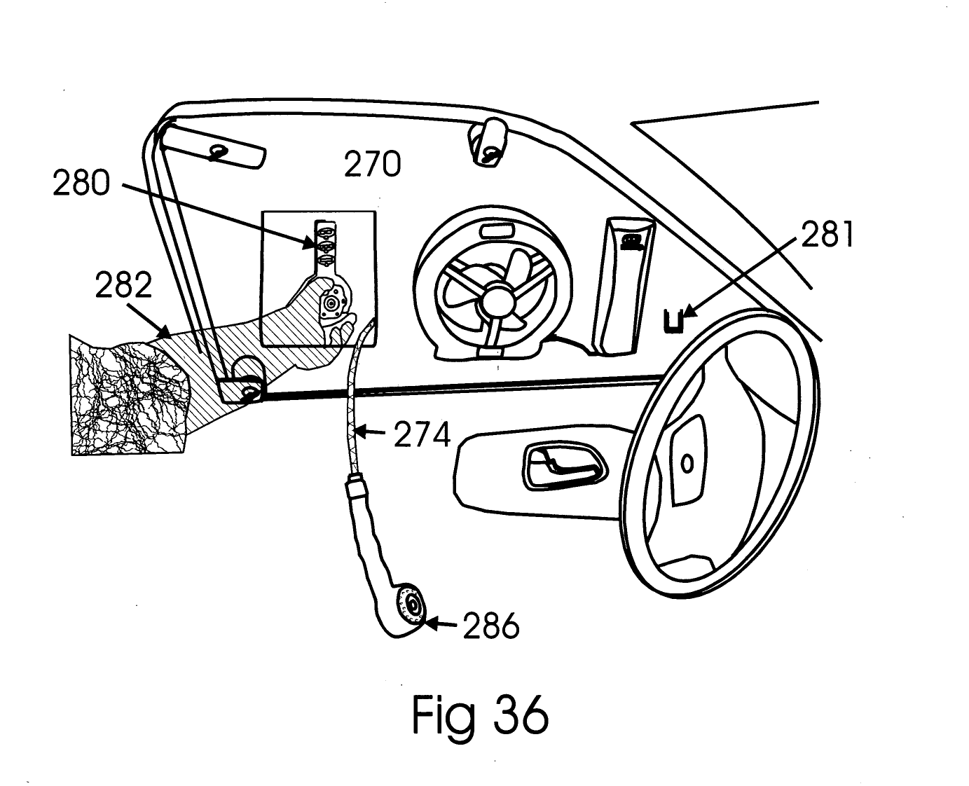

FIG. 35 shows a port adapter 270 with access door 272. It is one method of supplying hot water to the vehicle interior for bathing, cooking, or heating. The commercially available from the Coleman Company, Inc appliance model #2300-700 hot water heater 264 is resting on a spacer 276, which is a empty water can used for spacing here and waste water later. Spacer 276 is resting on the folding step ladder 278 [Household Step Stool Type III model 403-14 Tricom Ind Minn. 55344] to place the controls and indicators of water heater 264 at the proper level for access through the window adaptor 270. Folding step ladder 278 has the distinct advantage of being able to be easily stored in the small vehicles considered in this invention. Hot water flows out via tube 274 to the interior of the vehicle through the open access door 272 to a hand held shower head 286 shown in FIG. 36.

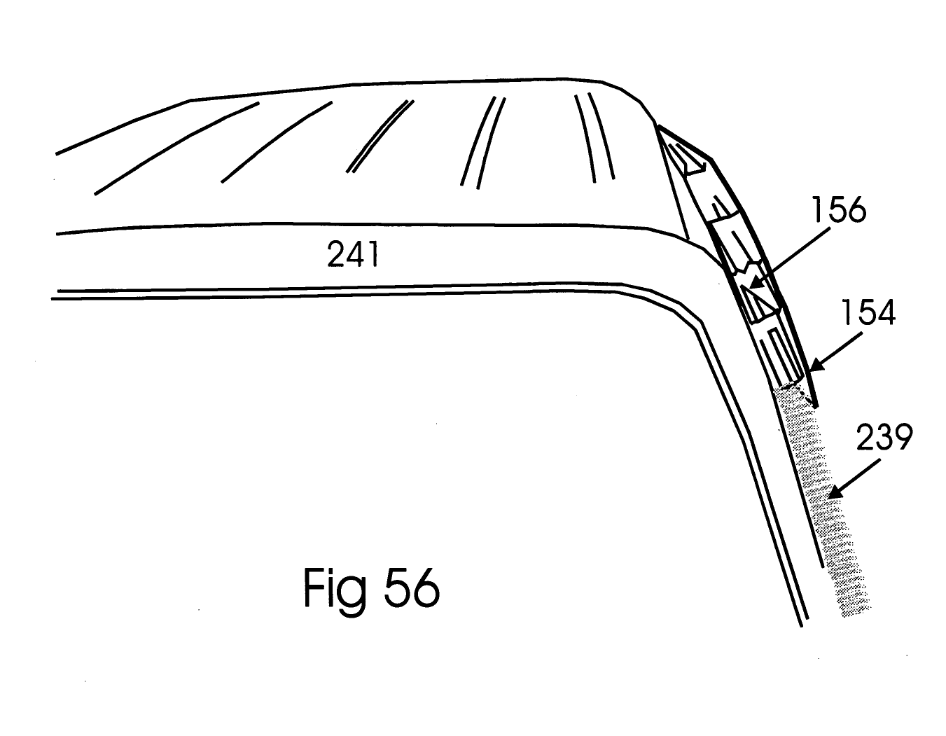

FIG. 36 is an inside view of adapter 270. FIG. 36 is an example of where a ventilation adapter is also used for a port adapter too. This is true for many adapters in this invention. See FIGS. 55, 56, & 60 for some other examples. Human arm and hand 282 is shown reaching thru the hole in adapter 270 to a dial that turns on the hot water and selects the temperature. The 3 indicator lights at 280 indicate the status of the hot water heater. 274 is the tubing carrying the hot water to shower head 286. Also a power port 281 allows an external 110 VAC power cord to be routed to an outlet outside the vehicle thereby enabling cooking appliances inside the vehicle to be used for cooking or heating.

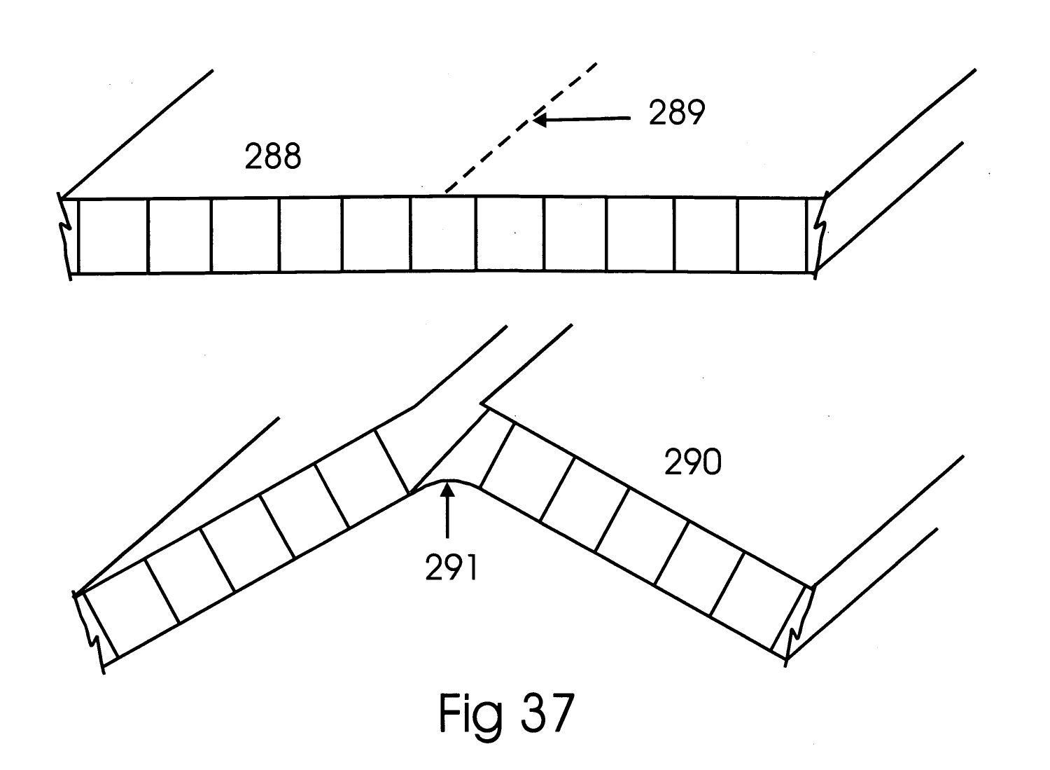

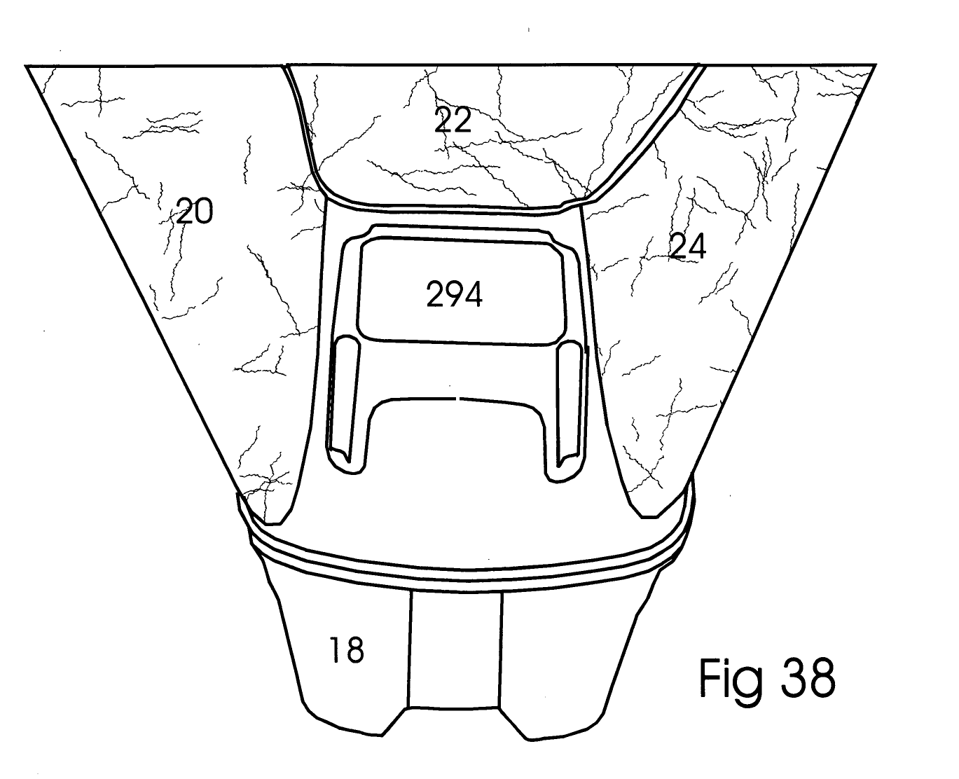

FIG. 37 is a detail describing the hinge of door 272 in FIG. 35. The door 272 is cut through both surfaces or walls of the twin-wall polycarbonate material on the bottom and both sides. The top of the door is formed into a living hinge shown at 291. A cut away portion of panel 288 has a dashed line at 289 that shows where the top surface (or wall) is cut to form the living hinge 291.

FIG. 38 shows a storage container used as a tub 18 that was shown in FIG. 1. It an accessory used in conjunction with other accessories that enables bathing. Splash guards 20, 22, and 24 are folding window shades [Auto Expressions-Magic shade sunshade by Axius “super jumbo size”] that keep the bathing water from splashing on the area around the tub 18 thus keeping the vehicle interior dry. Step stool 294 is used for the bather to sit on. The waste water accumulates in the bottom of tub 18 and can be removed after bathing by a drain tap in the bottom, or bucked out, or use a pump and hose into storage container 276 of FIG. 35. Also, all the bathing accessories and the commercial hot water heater can be used stand-a-alone without the vehicle and is a patentable idea in and of itself.

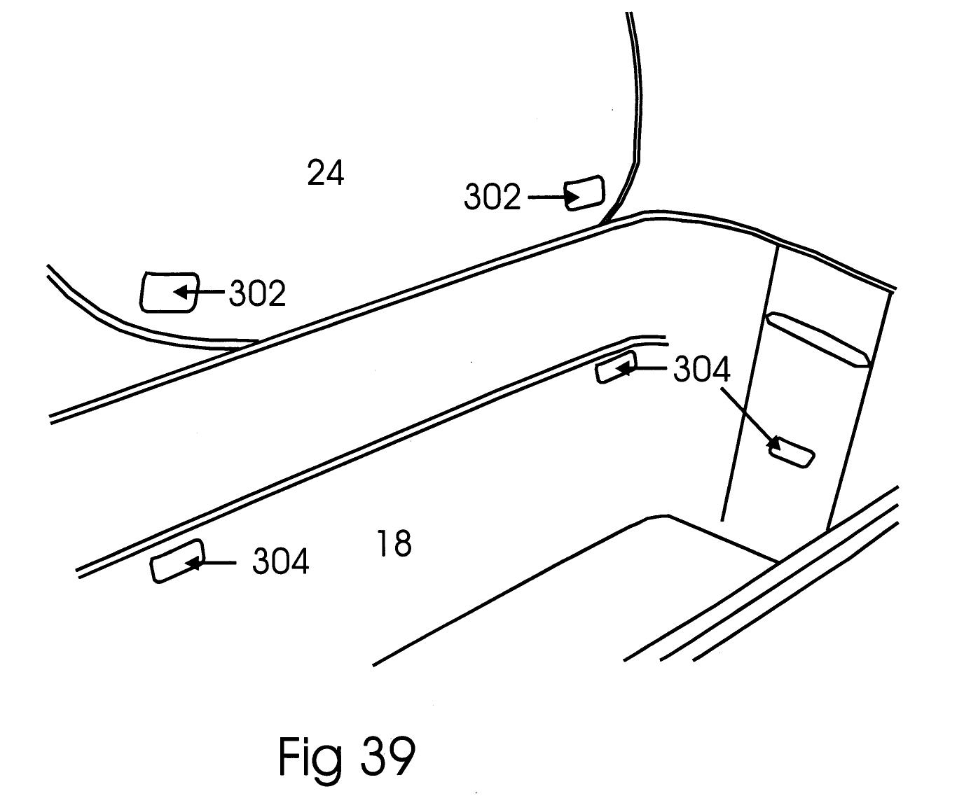

FIG. 39 shows how the splash guard 24 is attached to tub 18. Self-sticking hook and loop fasteners are used. Loop fasteners 302 are placed on splash guard 24. The mating hook fasteners 304 are attached to the corresponding location on tub 18.

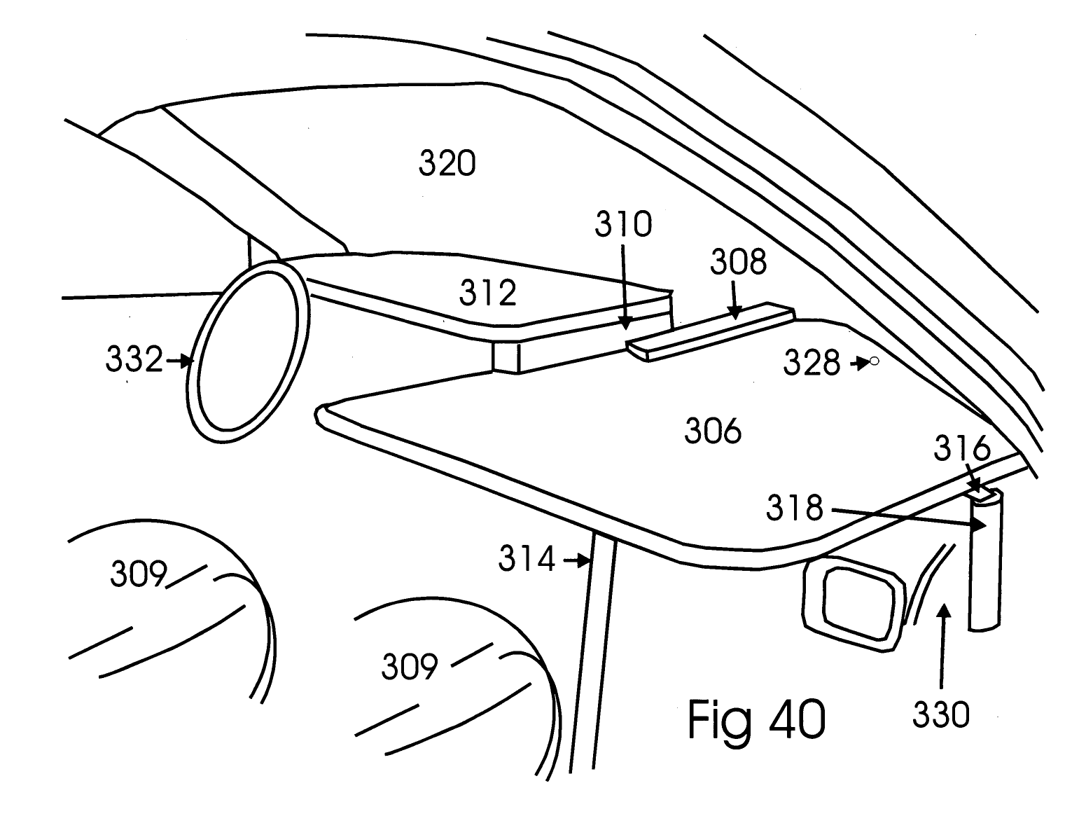

FIG. 40 shows a dash-mounted shelf 306. Shelf 306 is supported by one leg 314 at the rear edge of the shelf and by the vehicle dash at the front edge. Two points keep the dash from moving laterally. The first point is bolt 328 that protrudes down into a hole in the dash that is a grill for defrosting the windshield 320. The second point is a hose 318 over an angle iron 316 which is squeezed between the right hand end of the edge of the dash 330 and the vehicle door when the door is closed. Wedge board 308 pushes against the windshield 320 and forces the bolt 328 into the holes used for defrosting. This dash mounted shelf can be extended to the area in front of the steering wheel 332 by adding leveler block 310 and shelf 312. All parts are secured by hook and loop fastener pairs or can be bolted on if desired. Vehicle seats 309 are behind leg 314.

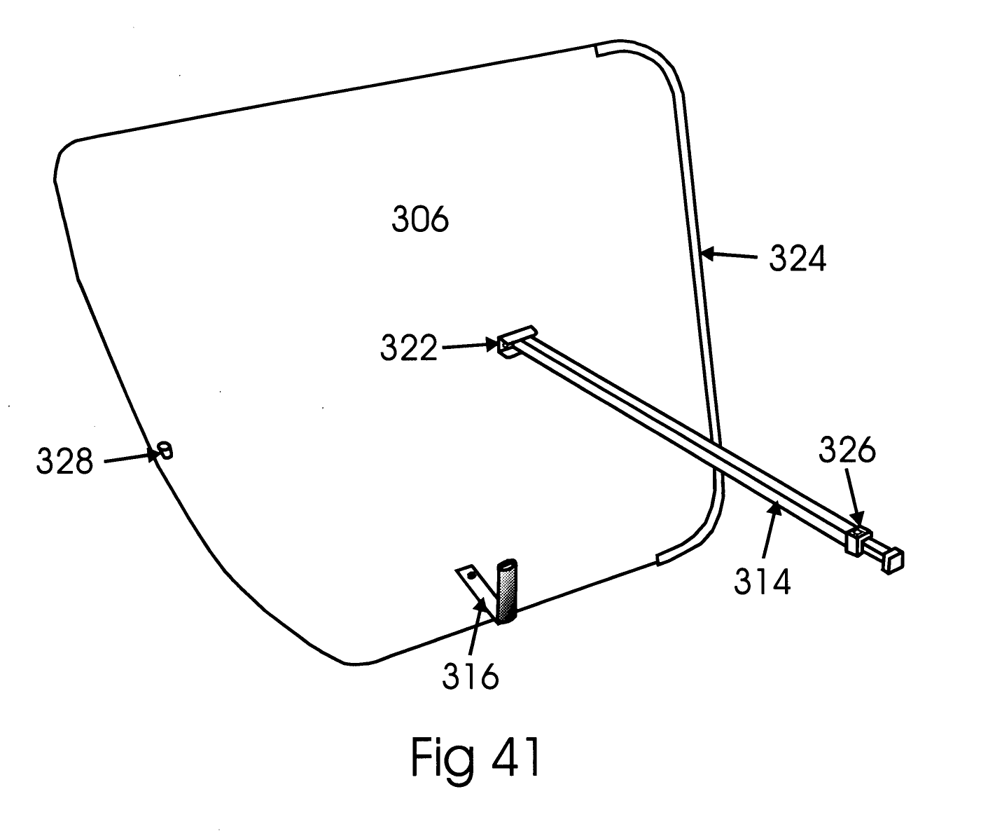

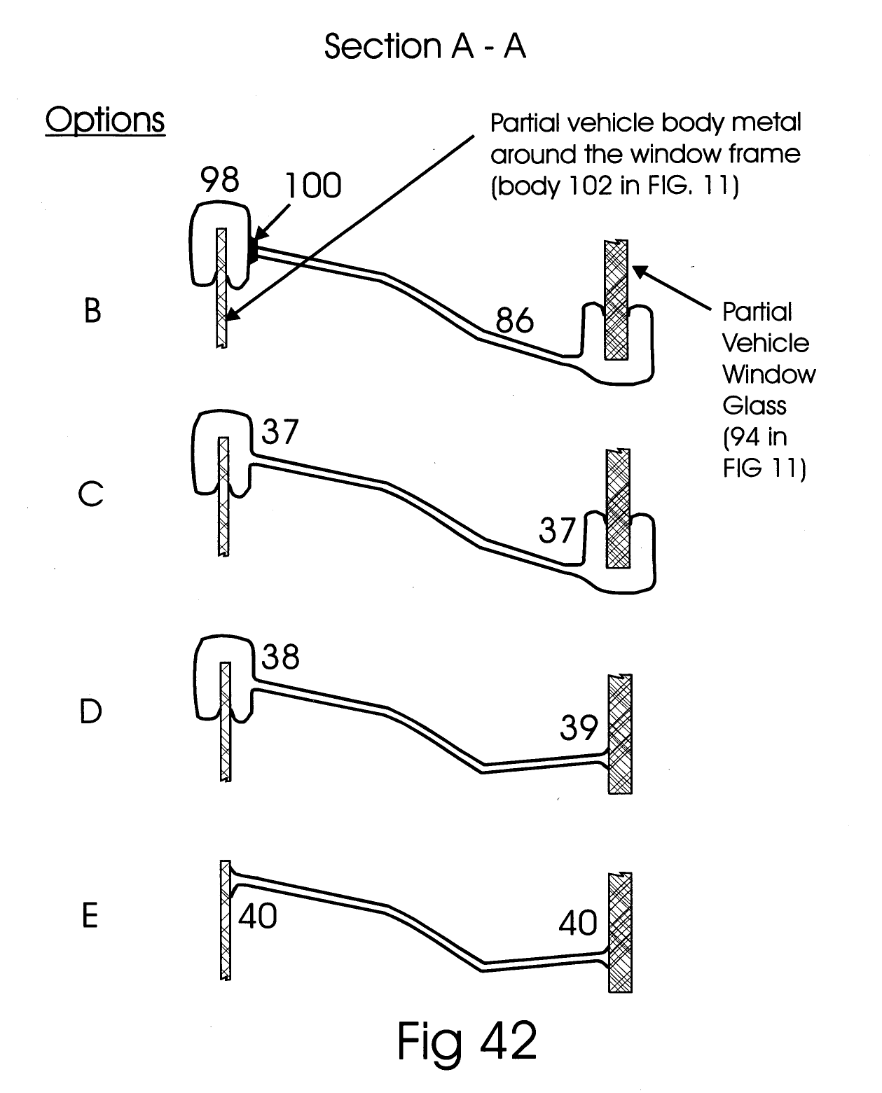

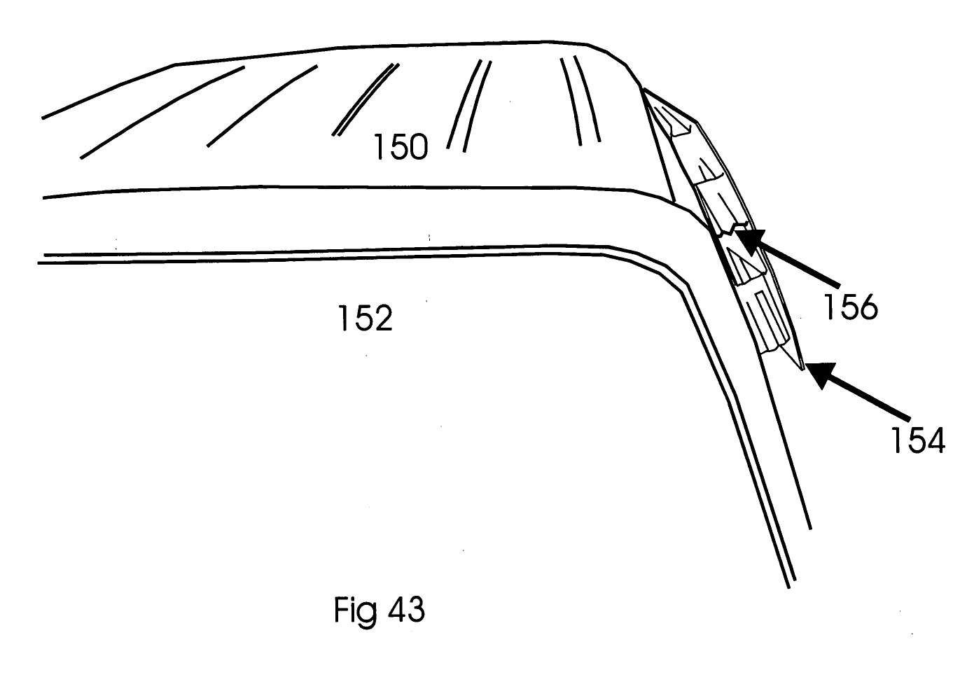

FIG. 41 shows the dash mounted shelf 306 removed from the vehicle with a bottom view. The curved edge at the left matches the curve where the windshield meets the dash on the right side (opposite side of driver). Item 328 is one or more bolts that will be inserted in the defrost vents at the windshield base. The bolt head is on top with a nut securing from the bottom and the excess bolt length protruding from the bottom of shelf 306 by ½″ to ¾ inches. Item 314 is an adjustable leg 314 to hold the front edge of the shelf close to horizontal. The smaller part at 326 telescopes into the larger portion of the leg. The leg is originally designed to be a lock for sliding glass doors. So this is a new application of the commercially available door lock. The leg 314 can be a fix length and not adjustable also. Edge trim 324 protects users from being hurt by a sharp edge and also is more attractive. Bolt 328 prevents fore and aft movement thus stabilizing the shelf Angle bracket 316 prevents side to side motion of the shelf

### FIGS. 42-60—Alternative Embodiments

The window covers typified by the example in FIG. 2 can also be fabricated of a single piece of UV resistant plastic or other materials that are made to fit snuggly, especially when a new vehicle is manufactured. Another alternative embodiment of a window cover could be a single or multiple panels that fit firmly in place and use a gasket material attached to some or all of the edges.

FIG. 42 shows 4 options for Section A-A of FIG. 11 that are different implementations of a natural ventilation adapter that is flexible so as to allow the window to be closed with the adapter installed. Any of the four options could replace the example in FIG. 11. What is illustrated in FIG. 11 is Option B which uses the existing vehicle seal 98 found on most of the louvered windows of today's minivans. This adapter consists of a modified Uni-Grip Inc bulb seal 86 (part number SD-170) which is attached to the existing window seal 98 with rubber adhesive 100. The bulb seal 86 holds the window side in place and the rubber adhesive 100 holds the other side of the adapter in place. Whereas option B can be retrofit to already manufactured vehicles, the next 3 option could be newly manufactured parts by automobile manufacturers when the vehicle is produced on the assembly line. Option C shows a newly designed seal with push-on channel clamp at both ends 37. Option D shows a push-on channel clamp at the vehicle body end 38 with an adhesive on the window end 39 when the window is manufacturered. Option E shows a manufacturer's adhesive at both ends 40 when the window is manufacturered.

FIG. 43 shows the top portion of the rear of the vehicle and illustrates another alternative embodiment of ventilation adapter 156. The vehicle top 150 has the rear window 152 shown below it. On the right side the opened louvered window 154 has ventilation adapter 156 consisting of one or more overlapping collapsible material that keep out the rain but allow interior air to flow out the bottom of each overlapping collapsible material 156 when the vehicle is moving. The above overlapping construction allows the windows to be open during a rain. The adapter can also have screening material (not shown) covering each opening to keep out insects. This entire assembly can be manufactured as part of a new vehicle grommet system. The four options shown in FIG. 42 apply to this ventilation adapter 156.

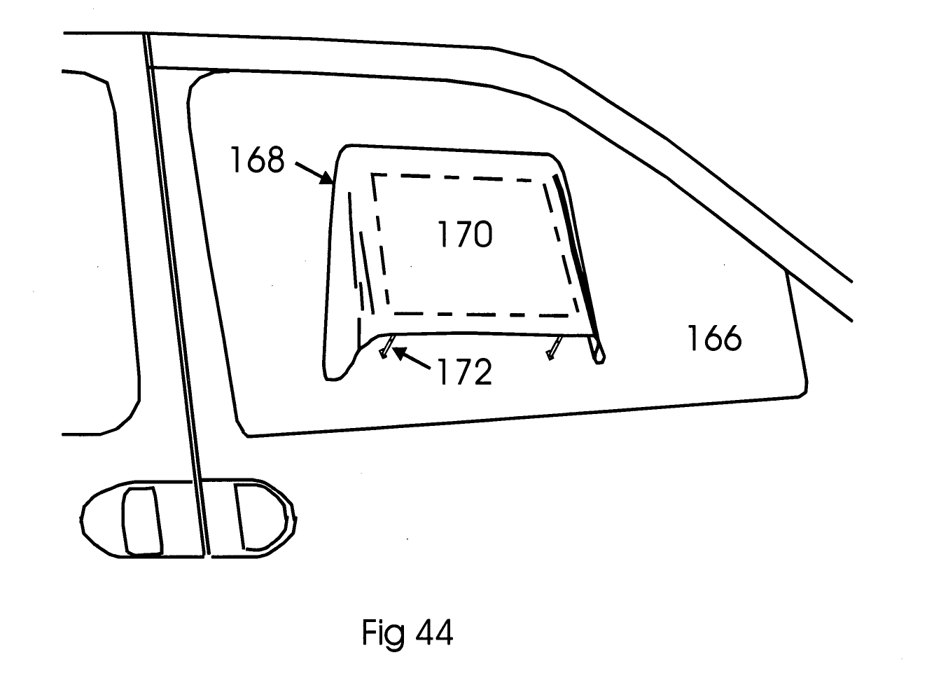

FIG. 44 shows a collapsible rain hood 168 on window ventilation adapter 166. It consists of a vinyl sheet attached at the top and both sides. The vinyl is held away from the window adapter 166 opening with a rigid plastic shown as a dashed rectangle 170 and held open or closed by commercially available shelf hinges 172. This rain hood 168 is an alternative embodiment of ventilation adapter rain hood 162 in FIG. 16. All items can be attached with a hook and loop fastening pair.

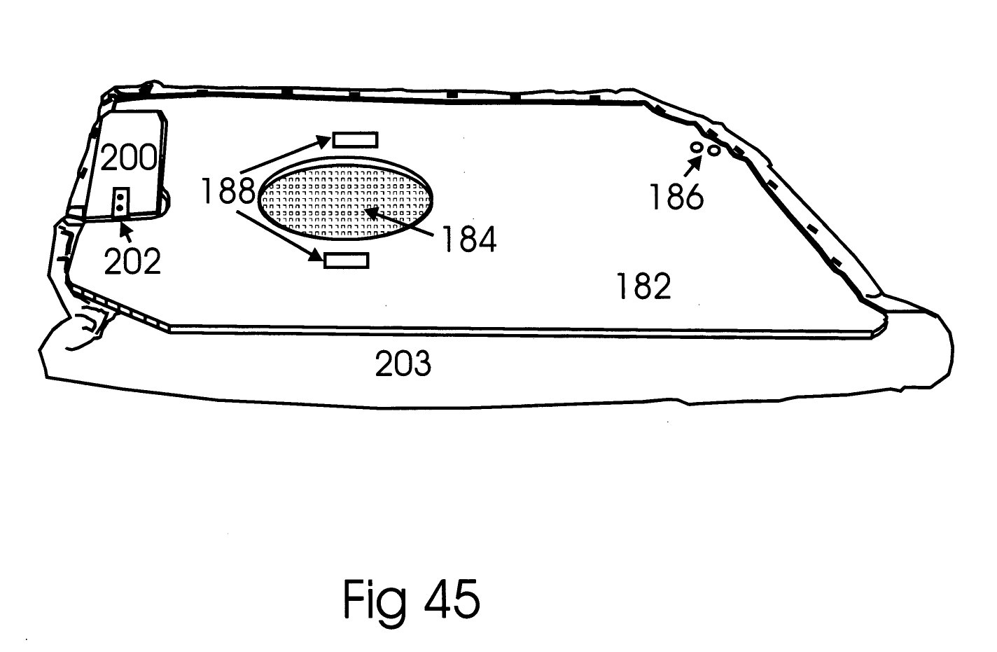

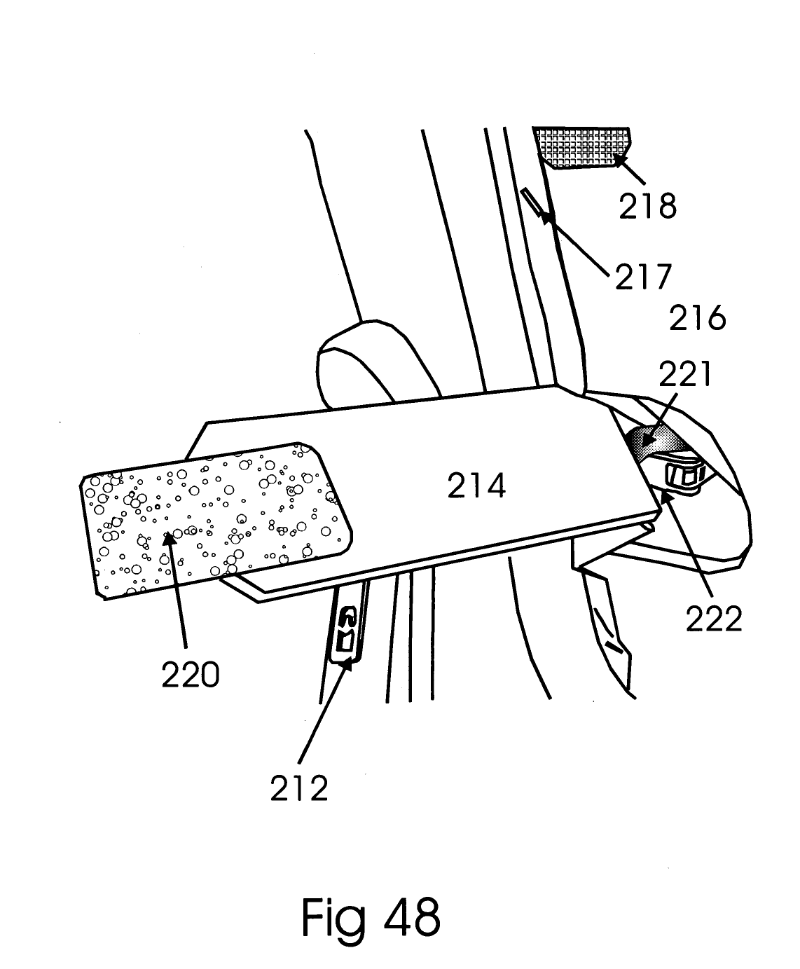

FIG. 45 shows an alternative embodiment of ventilation adapter as 182 that fits into a louvered window, when the window is fully extended open. This adapter is inserted from the inside of the vehicle on one of the windows on the driver's side. The upper right hand corner has 2 bolt heads 186 holding the bracket that will be described in FIG. 20. The fan mounts at the 2 loop fasteners 188 at the top and bottom of hole 184. Louvered windows have a latch at the rear edge to hold them open or closed. The lever 200 keeps the adapter pressed against the inside of the vehicle window. Lever 200 also has a part 202 that engages a portion of the window latch. More details of the lever operation will be shown in FIG. 48, 49, and 50. The vinyl sheet is stapled on 3 sides. The bottom edge of the vinyl 203 is made to hang out over the lower edge of the vehicle window to keep out rain.

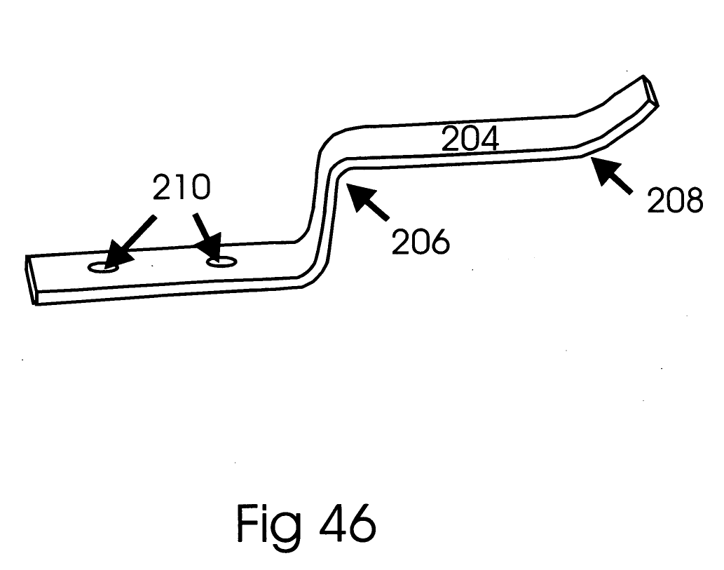

FIG. 46 is a common brass “L” bracket 204 modified with 2 bends 206 and 208 as shown. The 2 mounting holes are at 210.

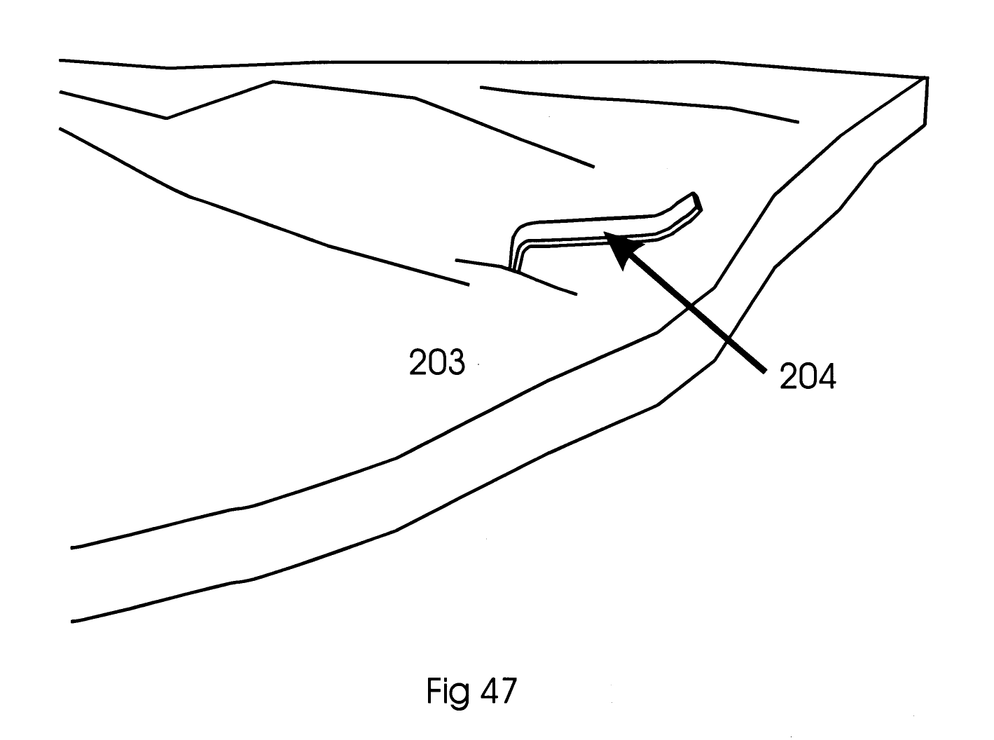

FIG. 47 is an outside view of the upper right hand corner. It shows the top part of the bracket 204 of FIG. 46 sticking up out of the vinyl material 203 that provides ultraviolet protection for the plastic sheet beneath.

In FIG. 48, 216 is the rear edge of the adapter in FIG. 45. The lever 214 is the same as lever 200 in FIG. 45. The hook, 218 and loop 220 will be joined together as illustrated in the next 2 figures. The window latch 222 previously mentioned is shown here.

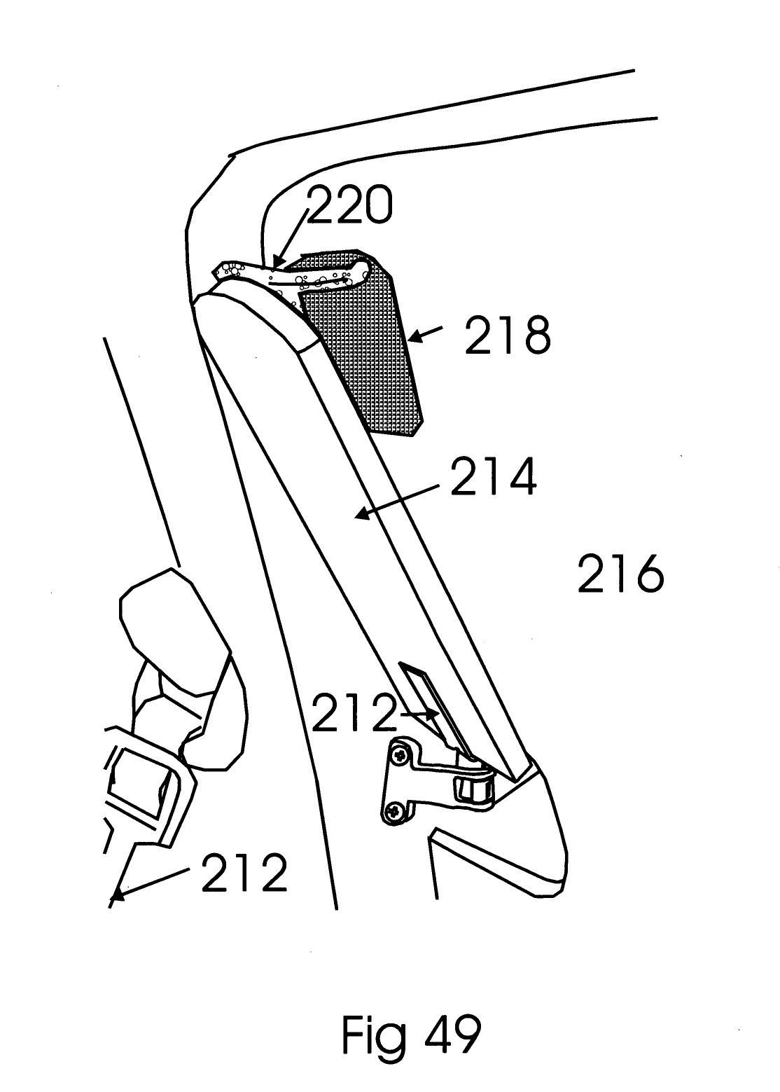

FIG. 49 shows the lever 214 in the partially closed position.

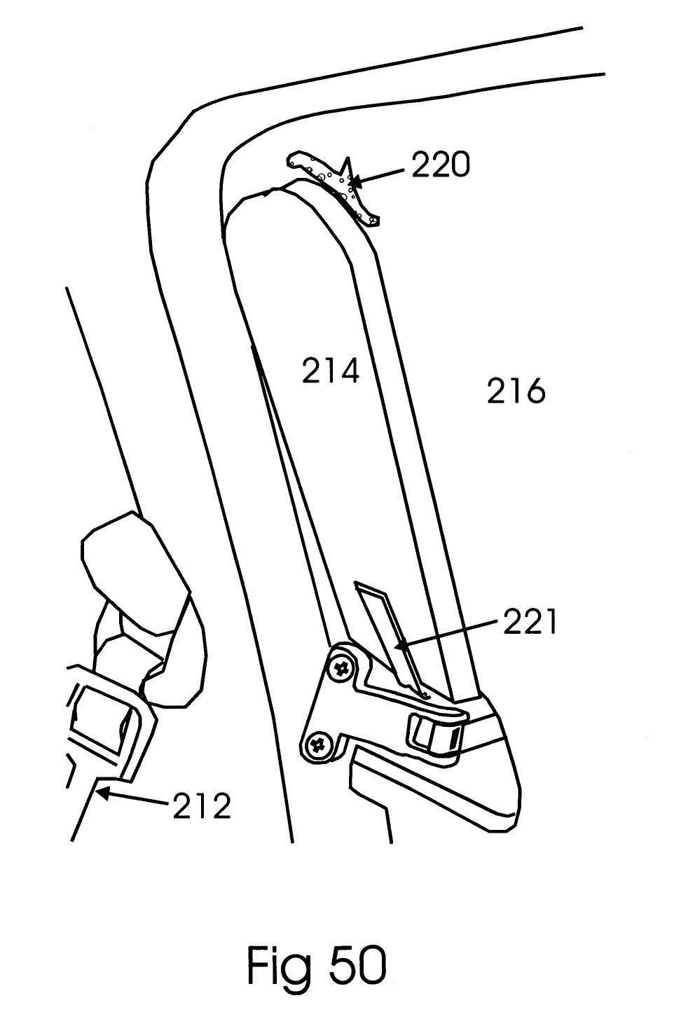

FIG. 50 show the lever 214 all the way closed.

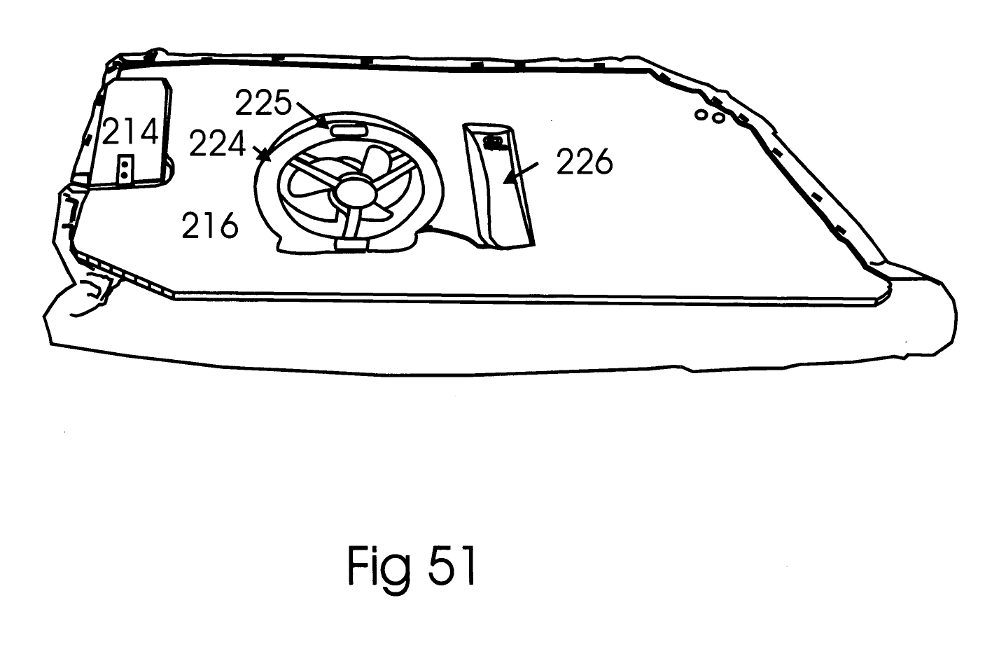

FIG. 51 shows the fan 224 and the battery pack 226 attached to the adapter with the hook fastener 225 at the top and the same at the bottom to allow for fan 224 to be reverse installed thus providing for exhaust or intake of air.

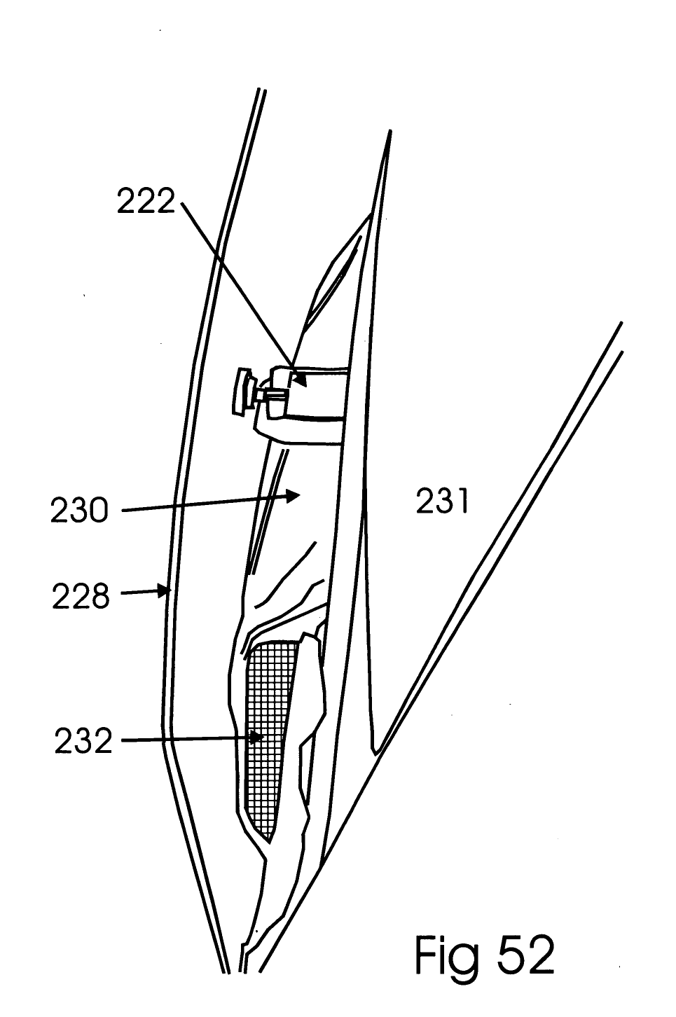

FIG. 52 is a view outside the vehicle from below the rear edge of the vehicle window 228 with another view of the window latch 222. The vinyl 230 makes a rain hood over rigid screen 232.

There are occasions where the vehicle needs conditioned air. This air can either be heated or cooled. The conditioning is done by appliances mounted external to the vehicle and may be resting on parts of the vehicle. Conditioned air needs to be ducted into the vehicle with a “source” ducting and a “return” ducting to permit circulation. The ducts need to have ports to get into the vehicle while keeping rain, small animals, and insects out.

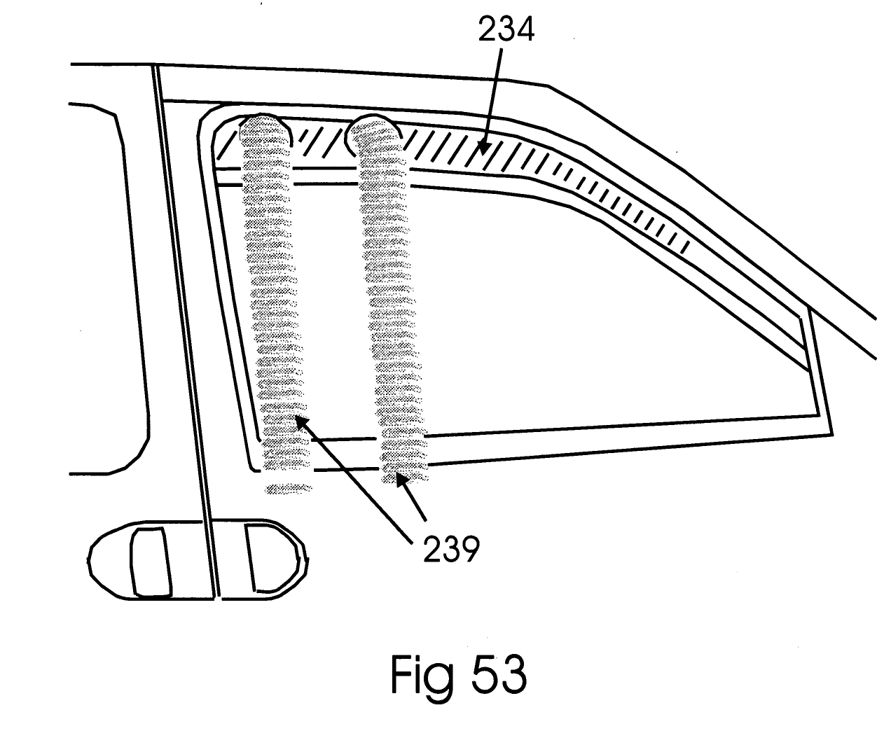

FIG. 53 shows a simple window adapter 234 that provides 2 ports for flexible tubing 239 to duct hot or cold air into the vehicle and also return air to an external appliance. The vehicle's window pane fits into a grove at the bottom of the adapter 234. This configuration uses a minimum amount of inserted material, however, the inserted material could replace as much of the window pane as desired.

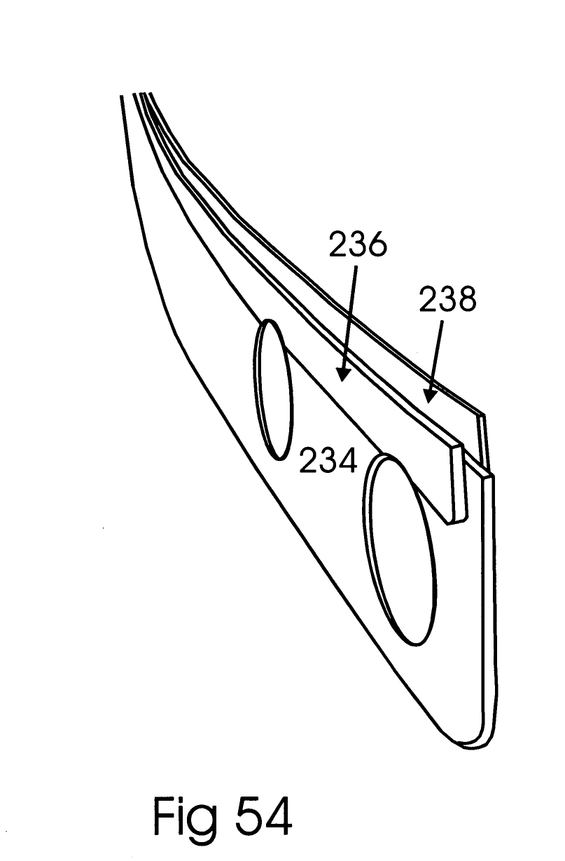

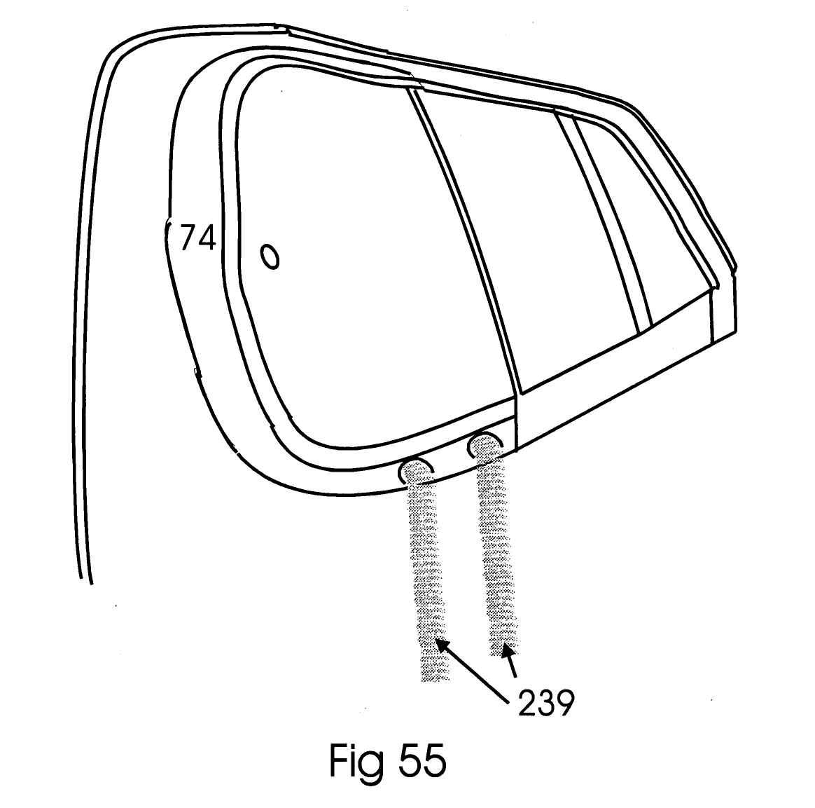

FIG. 54 shows the window adapter 234 from the previous FIG. 53 removed and inverted to show the construction details. Two identical strips 236 form a grove 238 for the window pane to fit into. The two identical strips 236 can be attached by several different means. The grove could also have a compressible material like a rubber grommet in it. The top portion of the adapter fits in the door top grove where the window pane normally fits when the window is completely closed. The window adapter can also be much larger or it could be fabricated as a single piece part.

FIG. 55 is another example of a port adapter used for ducting. The flap 74 of FIG. 7 with the ventilation holes replaced with ports for flexible tubing ducts 239.

FIG. 56 shows the vehicle tailgate 241 with adapter 156 and yet is another example of providing ports for flexible tubing ducts 239. The options of FIG. 42 apply here too.

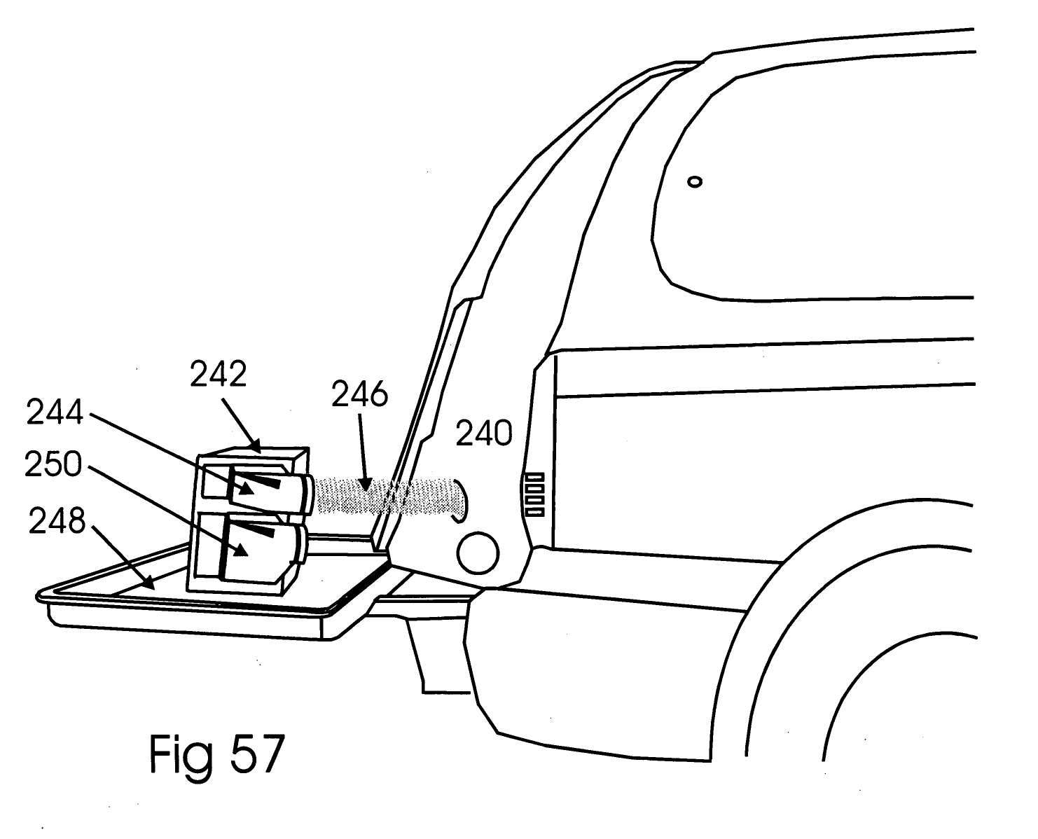

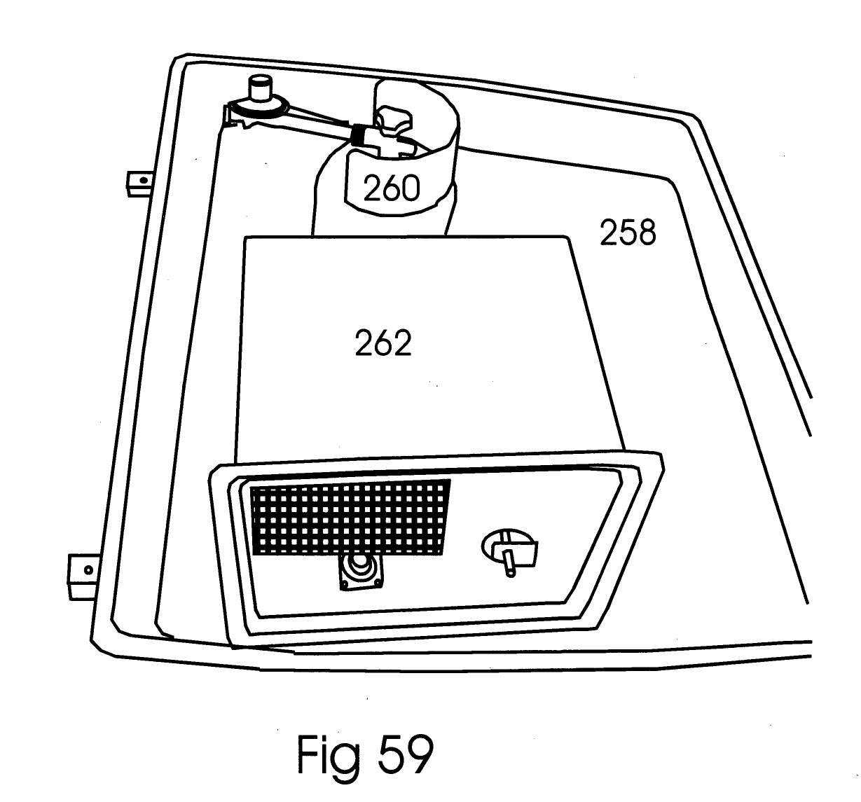

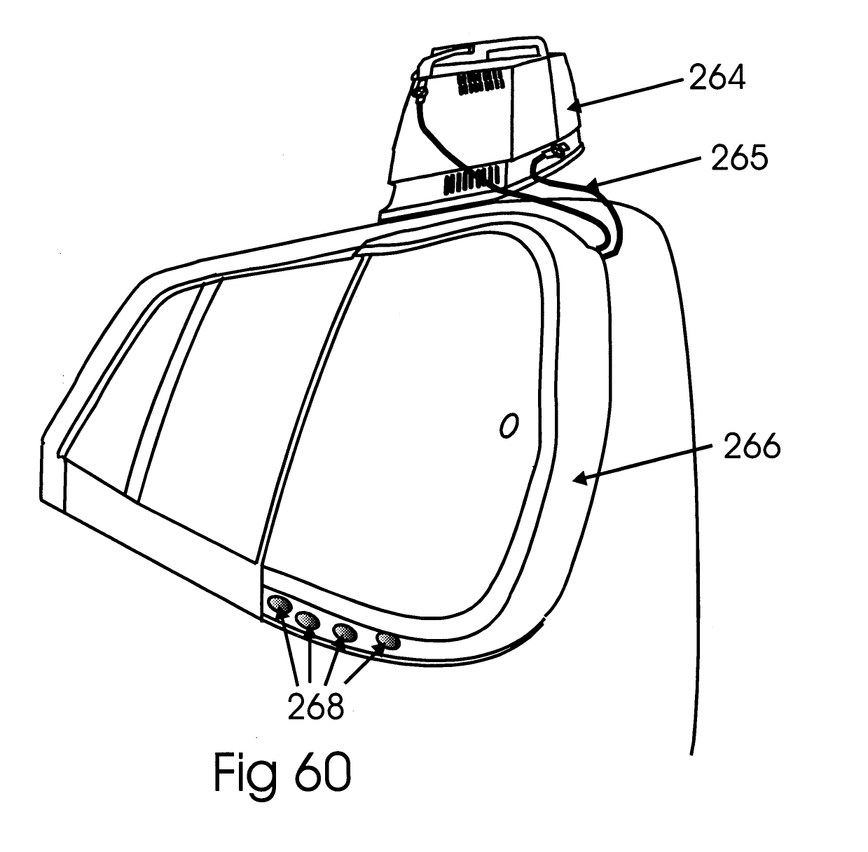

FIG. 57 shows accessories to facilitate the preferred method of cooling or heating the interior of said vehicle without said vehicle's motor operating, providing ports are provide which are in the tailgate adapter 240. An air conditioner unit 242 has an upper manifold 244 and flexible ducting 246. The air conditioner unit 242 is mounted on hitch carrier 248. The second return manifold 250 does not have the ducting shown here but is needed for normal operation. Normal items stored on the hitch carrier 248 can include: bicycles, an air conditioner or a heater. Only the air conditioner or a heater is considered a new idea when the ducting is done through the tail gate adapter 240. Holes are shown are sized for air ducting. For water hoses, the holes could obviously be smaller. The hole locations can be either on the sides as shown or on the bottom of the adapter (not shown). The hot water heater and the LP gas tank shown in FIGS. 59 and 60 could also be mounted on the hitch carrier 248. Mounting the heavier appliances on the hitch carrier has the advantage over the roof mounting because of possible weight limitations. It is also easier to install or remove and easier to secure against the unlikely event of a head-on collision. Using the medium of air for heating or cooling has the advantage that no additional appliance is needed in the interior of the vehicle. This is contrasted to water being used as a medium where the heated water needs a heater core with a fan to heat the interior. FIG. 57 shows an air conditioner 242 but an LP gas heater like those used in RVs could also have manifolds for conduits similar to that shown in FIG. 57.

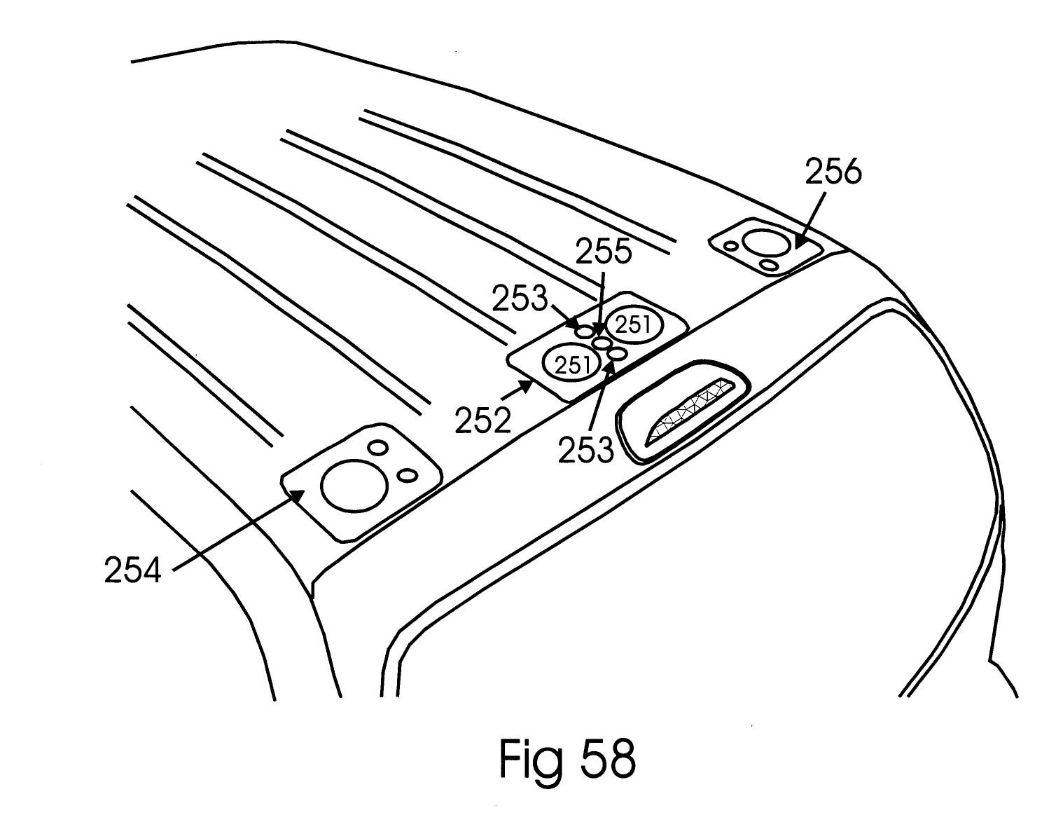

FIG. 58 shows another method of supplying ports to a vehicle without adding window or tailgate opening adapters. In the center of the top rear edge of the vehicle roof is a double interface panel 252 mounted in the surface of the vehicle itself, consisting of two air port connectors 251 with covers as well as two water connectors 253 and one electrical connector 255 that has multiple contacts. An alternative to the double interface panel 252 is a single supply interface panel 254 consisting of one air port connector, and one water connector and one electrical connector that has multiple contacts for power and control signals. To provide return air and water flow, a matching single interface panel 256 is shown. Either double or single interface panels can be located anywhere on the vehicle top, sides, or rear tailgate area. If located in the tail gate area, the tailgate itself will need to be modified similar as it is for tail lights that are mounted on the vehicle rear without being part of the tailgate. These interface panels need covers on the individual connects when not being used and could have all connectors recessed to allow for a cover over the entire panel itself allowing it to be flush with the rest of the vehicle surface. These panels can be part of the original manufacture of the vehicle or they can be added as a retrofit.

FIG. 59 shows a portable enclosure 258 that mounts on top of a vehicle. The enclosure cover is not shown. Hot water heater 262 and LP gas tank 260 can be secured by several common means. Hoses to connect to a port adapter are not shown.

FIG. 60 shows hot water heating appliance mounted on the roof but not in an enclosure like FIG. 59. Plastic hose 265 is routed through adapter 266 thereby providing the ports. In order to control the water temperature and flow rate, the controls must be operated remotely with mechanical control cables or an electronic servo. Hot water heater 264 shown is a Coleman Company, Inc “hot water on demand” appliance model #2300-700 which pumps water from a collapsible container via pump, both also from Coleman with the water heater and not shown here. Any hot water heater appliance can be used to heat the water.

Various changes and modifications can be made to the above-described accessories without departing from the spirit of the invention. Such changes and modifications are contemplated by the inventor and he does not wish to be limited except by the scope and spirit of the appended claims.

Operation—FIGS. 1, 4-7, 11, 12, 16, 18, 35, 36, 40

After all accessories are fit and assembled as described in the preferred embodiment, they are normally stored out of the vehicle until a time when the vehicle is used for a camping excursion. At that time all accessories are moved to the cargo carrying area of the vehicle for storage and transporting to the camp site. At the camp site some accessories are installed for a function such as bathing or cooking and removed as soon as the function is completed. Other accessories are installed and left installed until the end of camping. The first accessory is left installed all the time. Listed below is a suggested order of function provided by these accessories:

a) FIG. 11 is a permanently installed accessory and looks like FIG. 12 when the window is closed.

b) install window coverings per FIGS. 4, 5, and 6.

c) install ventilation adapters as typified in FIGS. 7, 16, and 18.

d) install port adapter 270 as typified in FIGS. 35 and 36.

e) when ready to cook:
install shelf 306 as shown in FIG. 40,
place an electric appliance on the shelf (examples might be: electric frying pan, toaster, microwave oven, etc)
run an extension cord thru port 281 in adapter 270 shown in FIG. 36 to a 110 VAC power outlet outside the vehicle.
remove when done cooking.

f) When ready to bath:
install tub 18 and splash guards 20, 22, and 24 per FIG. 1. Splash guards 20, 22, and 24 are temporarily attached to tub 18 as shown in FIG. 39.
set up FIG. 35 items 278, 276, 264, and 274 in that order.
add item 286 of FIG. 36 and place it in tub 18 of FIG. 1 for the bather to use,
reach arm 282 thru port adapter 270 as shown in FIG. 36,
turn on hot water for bathing while watching indicators 280 in FIG. 36.
turn off hot water when done, remove waste water from tub 18.
dry off and remove all accessories added for bathing.

g) when ready to sleep:
fold down or remove all seats (not shown) in the cargo carrying area
place a mattresses (if desired) and bedding (both not shown) in the cargo carrying area.
when done using the bed, store items for traveling.

h) before breaking camp, store all accessories securely for traveling.

The embodiments of the invention in which an exclusive property or priviledge is claimed are defined as follows:

1. In a sports utility vehicle, minivan, and van, collectively referred to in these claims as a “vehicle”, having a driver's seat and a first passenger's seat located adjacent said driver's seat and having a cargo carrying area provided with additional passenger seats removably mounted to a horizontal floor portion or said additional passenger seats storable under a horizontal floor portion of said vehicle floor located to the rear of said driver's seat and said first passenger's seat, said vehicle including a tailgate at its rear end and a pair of laterally spaced side walls that include a plurality of louvered windows that swings open at the rear edge and said louvered windows are hinged at the front edge with a vertically mounted hinge, said vehicle also having a driver's window that stores inside the lower portion of the driver's door when opened, said vehicle removably equipped with accessories to provide camping functions, window covers provide privacy function, tub with splash guards provide bathing function, dash-mounted shelf enables cooking functions, forced ventilation adapters which uses a fan to remove odors, natural ventilation adapters to remove odor without a fan, port adapters which provide ports for conduits, access door adapters that contain doors for human hands to reach through and control an externally mounted appliance, and combination adapters that have one or more functions of the previously mentioned adapters, said vehicle having said driver's window completely opened and said combination adapter inserted in said driver's window, said combination adapter having said access door and said forced ventilation adapter, said combination adapter consisting of a rigid panel cut slightly larger than said driver's window opening to allow for a water seal to be place around the entire perimeter of said driver's window opening, said combination adapter install from the outside and aligned by 4 levers, one in each corner of driver's window opening, said levers secured by carriage bolt and wing nut, said levers being spaced by 2 inch diameter rod cut to length such that said levers overlap the interior door frame around said driver's window opening and holds said rigid panel firmly against said exterior of said driver's window opening, said access door being hinged at the top edge allowing access for a human hand to reach controls on an external appliance, additionally said rigid panel may have a fan with a screen on the inside and a rain hood on the outside, said access door also providing a port for said conduit from said external appliance to deliver hot water to a shower head for bathing with the temporary addition of a storage container large enough for an adult to sit in, said storage container previously called said tub is used for catching bathing waste water, said tub having a plurality of sun shades temporarily attached to the perimeter of said tub to prevent splashing of bathing water outside of said tub, thereby protecting said cargo carrying area floor from water damage, said tub and said a plurality of sun shades can be used with the hot water appliance and hand-held shower head outside said vehicle in a stand-alone application if desired, when said external appliance is said hot water heater used for bathing the preferred mounting is on a portable, collapsible support structure, said support structure is preferably a folding step stool for reasons of easy and compact storage, said hot water heater being placed upon said support structure with appropriate spacers to make said hot water heater controls at the same height as said access door opening on said combination adapter, said hot water heater controls positioned at a horizontal distance no greater than 10 inches from said access door opening, alternately, one of said louvered windows can be used with all-weather and insect proof said natural ventilation adapter by cutting commercially available flap seal to a length of said louvered window's perimeter less the length of the said louvered window's hinge, then installing said flap seal with the said louvered window open, said flap seal being held in place by the push-on clamp channel that has a metal spring, said metal spring being removed from last 4 inches of each end of said flap seal, bottom side of said flap seal has ventilation holes, said ventilation holes being covered with screening material to keep insects and small animals out, additionally, one of said louvered windows can be used with all-weather and insect proof said natural ventilation adapter by cutting a commercially available bulb seal to a length of said louvered window's perimeter less the length of the window's hinge, then modifying said bulb seal by cutting open the bulb at the line where said bulb meets the body of said push-on clamp channel on one side thereby making said bulb seal have a new flap that resembles the flap of said flap seal, then installing said bulb seal with the window open, said bulb seal being held in place by push-on clamp channel that has a metal spring, said metal spring being removed from last 4 inches of each end of said bulb seal, said new flap is thin and is very flexible, said new flap is then attached to said vehicle's existing window seal with rubber cement, bottom side of new flap has ventilation holes, said ventilation holes being covered with said screening material to keep insects and small animals out, most natural ventilation adapters can be used as said port adapters when said screening material applied to the holes on the bottom of said natural ventilation adapters is removed and said ventilation holes are occupied by said conduits, said conduits having the ability to connect to other said external appliances, said vehicle removably equipped with window covers, said functionality also including total privacy with the addition of window covers that can be easily installed and removed without the modification of said vehicle, said total privacy provided by said window covers blocking sight into said vehicle from outside of said windows, all windows include said louvered windows, said driver's window, front seat passenger's window, windshield, and tailgate windows, said window covers being comprised of a semi-rigid core material roughly the size of the inside area of said all windows and said semi-rigid core being covered on the exterior side by an opaque material, said opaque material preferably being larger than said semi-rigid core so as to provide a visual seal around the perimeter of said all window covers, said semi-rigid core material being held against the inside of said all windows by friction fit, said visual seal formed by folding the extra said opaque material to make a half inch lip when said opaque material is stapled to said semi-rigid core material, said window covers could alternately be a single plastic unit that is molded to fit each said all windows, said single plastic unit may also have a seal attached to it, to facilitate said bathing said external appliance was said hot water heater, an alternate said external appliance can be used to cool or heat the interior of said vehicle, whereas said support structure for said hot water heater was said folding step stool, the preferred said support structure for said external appliance to be used to cool or heat can be mounted at two different locations, said external appliances being preferably mounted on top of said vehicle, said vehicle also being equipped with a hitch receiver, and a removable hitch mounted platform being attached to said hitch receiver as an alternate mounting location for said external appliances, said platform having sufficient area and strength to support said appliance, with ports for said external appliance conduits being provided by a tailgate adapter that is inserted into said tailgate opening when said tailgate is partially opened and said tailgate adapter prevents rain and insects from entering said cargo area, all the above said temporarily added functionality being combined to provide an acceptably small, but private room inside said vehicle for camping functions such as sleeping, bathing, cooking, and private activities while keeping rain and insects out of said vehicle, additional camping functionality includes a dash-mounted shelf to support cooking or fan devices, said dash-mounted shelf made of rigid core material cut in a square approximately 30 inches by 30 inches with the front side next to the windshield being cut to match the curve of said windshield, said dash-mounted shelf sides being parallel to said laterally spaced side walls, said dash-mounted shelf is supported in the front by the dash of said vehicle, the rear edge of said dash-mounted shelf is supported by a leg reaching to said horizontal floor portion, said dash-mounted shelf secured from lateral movements by two or more restraining points, said restraining points being implemented with posts that protrude down into the grate provided for defrosting of said windshield, all items being added to said vehicle to provide said functionality being such that said vehicle has no permanent modifications and can be restored to the original configuration with the removal of most added functional accessories.

2. The vehicle of claim 1 limited to said vehicle having said driver's window completely opened and said combination adapter inserted in said driver's window, said combination adapter having said access door and said forced ventilation adapter, said combination adapter consisting of a rigid panel cut slightly larger than said driver's window opening to allow for a water seal to be place around the entire perimeter of said driver's window opening, said combination adapter install from the outside and aligned by 4 levers, one in each corner of driver's window opening, said levers secured by carriage bolt and wing nut, said levers being spaced by 2 inch diameter rod cut to length such that said levers overlap the interior door frame around said driver's window opening and holds said rigid panel firmly against said exterior of said driver's window opening, said access door being hinged at the top edge allowing access for a human hand to reach controls on an external appliance, additionally said rigid panel may have a fan with a screen on the inside and a rain hood on the outside, said access door also providing a port for said conduit from said external appliance to deliver hot water to a shower head for bathing with the temporary addition of a storage container large enough for an adult to sit in, said storage container previously called said tub is used for catching bathing waste water, said tub having a plurality of sun shades temporarily attached to the perimeter of said tub to prevent splashing of bathing water outside of said tub, thereby protecting said cargo carrying area floor from water damage, said tub and said a plurality of sun shades can be used with the hot water appliance and hand-held shower head outside said vehicle in a stand-alone application if desired, when said external appliance is said hot water heater used for bathing the preferred mounting is on a portable, collapsible support structure, said support structure is preferably a folding step stool for reasons of easy and compact storage, said hot water heater being placed upon said support structure with appropriate spacers to make said hot water heater controls at the same height as said access door opening on said combination adapter, said hot water heater controls positioned at a horizontal distance no greater than 10 inches from said access door opening.

3. The vehicle of claim 1 limited to one of said louvered windows can be used with said natural ventilation adapter by cutting a commercially available bulb seal to a length of said louvered window's perimeter less the length of the window's hinge, then modifying said bulb seal by cutting open the bulb at the line where said bulb meets the body of said push-on clamp channel on one side thereby making said bulb seal have a new flap that resembles the flap of said flap seal, then installing said bulb seal with the window open, said bulb seal being held in place by push-on clamp channel that has a metal spring, said metal spring being removed from last 4 inches of each end of said bulb seal, said new flap is thin and is very flexible, said new flap is then attached to said vehicle's existing window seal with rubber cement, bottom side of new flap has ventilation holes, said ventilation holes being covered with said screening material to keep insects and small animals out.

4. The vehicle of claim 1 limited to said vehicle equipped with window covers to provide said total privacy that can be easily installed and removed without the modification of said vehicle, said total privacy provided by said window covers blocking sight into said vehicle from outside of said windows, all windows include said louvered windows, said driver's window, front seat passenger's window, windshield, and tailgate windows, said window covers being comprised of a semi-rigid core material roughly the size of the inside area of said all windows and said semi-rigid core being covered on the exterior side by an opaque material, said opaque material preferably being larger than said semi-rigid core so as to provide a visual seal around the perimeter of said all window covers, said semi-rigid core material being held against the inside of said all windows by friction fit, said visual seal formed by folding the extra said opaque material to make a half inch lip when said opaque material is stapled to said semi-rigid core material, said window covers could alternately be a single plastic unit that is molded to fit each said all windows, said single plastic unit may also have a seal attached to it.

5. The vehicle of claim 1 limited to a dash-mounted shelf to support cooking or fan appliances, said dash-mounted shelf made of rigid core material cut in a square approximately 30 inches by 30 inches with the front side next to the windshield being cut to match the curve of said windshield, said dash-mounted shelf sides being parallel to said laterally spaced side walls, said dash-mounted shelf is supported in the front by the dash of said vehicle, the rear edge of said dash-mounted shelf is supported by a leg reaching to said horizontal floor portion, said dash-mounted shelf secured from lateral movements by two or more restraining points, said restraining points being implemented with posts that protrude down into the grate provided for defrosting of said windshield.

6. A stand-alone bathing capability consisting of accessories described for the vehicle of claim 1 limited to all accessories being used outside said vehicle, external appliance to deliver hot water to a shower head for bathing with a tub large enough for an adult to sit in used for catching bathing waste water, said tub having a plurality of sun shades temporarily attached to the perimeter of said tub to prevent splashing of bathing water outside of said tub, said tub used with the hot water appliance and hand-held shower head, said hot water heater mounted on a support structure such that said hot water heater controls are at a convenient height and distance for bather to adjust while sitting in said tub and holding said hand-held shower head.

7. A method for equipping a vehicle containing one open said louvered window, said driver's window which is totally open and said passenger's window with accessories for one or more of the following functions: bathing, ventilation, privacy and cooking comprising the steps of:
a) install said combination adapter in said driver's window, said combination adapter having said access door, said combination adapter consisting of said rigid panel cut slightly larger than said driver's window opening to allow for a water seal to be place around the entire perimeter of said driver's window opening, said combination adapter installed from the outside of vehicle and aligned by 4 levers, one in each corner of said driver's window opening, said levers secured by carriage bolt and wing nut, said levers being spaced away from said rigid panel by 2 inch diameter rod cut to length such that said levers overlap the interior door frame around said driver's window opening and holds said rigid panel firmly against said exterior of said driver's window opening, said access door being hinged at the top edge allowing access for a human hand to reach controls on an external appliance;
b) install the temporary addition of said tub large enough for an adult to sit in, said tub is used for catching bathing waste water, install said support structure, preferably being said folding step stool for reasons of easy and compact storage;
c) install a plurality of sun shades temporarily attached to the perimeter of said tub to prevent splashing of bathing water outside of said tub, thereby protecting said cargo carrying area floor from water damage;
d) install said hot water heater used for bathing on said folding step stool, said hot water heater being placed upon said support structure with appropriate spacer to make said hot water heater controls at the same height as said access door opening on said combination adapter, said hot water heater controls positioned at a horizontal distance no greater than 10 inches from said access door opening; said access door also providing a port for said conduit from said external appliance to deliver hot water to a shower head in said tub for bathing, said tub having a plurality of sun shades temporarily attached to the perimeter of said tub to prevent splashing of bathing water outside of said tub;
e) in said louvered window, install said natural ventilation adapter by cutting commercially available flap seal to a length of said louvered window's perimeter less the length of the said louvered window's hinge, then installing said flap seal, said flap seal being held in place by the push-on clamp channel that has a metal spring, said metal spring being removed from last 4 inches of each end of said flap seal, bottom side of said flap seal has ventilation holes, said ventilation holes being covered with screening material to keep insects and small animals out;
f) install said forced ventilation adapter that allows interior air of said vehicle to be exchanged with outside air with the aid of an electric fan, said forced ventilation adapter covering a portion or all of said front passenger's window when said window is opened;
g) on the remaining windows of said vehicle, install said window covers, to provide said total privacy, said total privacy provided by said window covers blocking sight into said vehicle from outside, said window covers being comprised of a semi-rigid core material roughly the size of the inside area of said all windows and said semi-rigid core being covered on the exterior side by an opaque material, said opaque material preferably being larger than said semi-rigid core so as to provide a visual seal around the perimeter of said all window covers, said semi-rigid core material being held against the inside of said all windows by friction fit, said visual seal formed by folding the extra said opaque material to make a half inch lip when said opaque material is stapled to said semi-rigid core material, said window covers could alternately be a single plastic unit that is molded to fit each said all windows, said single plastic unit may also have a seal attached to it;
h) install said dash-mounted shelf to support cooking or fan appliances, said dash-mounted shelf made of rigid core material cut in a square approximately 30 inches by 30 inches with the front side next to the windshield being cut to match the curve of said windshield, said dash-mounted shelf sides being parallel to said laterally spaced side walls, said dash-mounted shelf is supported in the front by the dash of said vehicle, the rear edge of said dash-mounted shelf is supported by a leg reaching to said horizontal floor portion, said dash-mounted shelf secured from lateral movements by two or more restraining points, said restraining points being implemented with posts that protrude down into the grate provided for defrosting of said windshield.

8. A method for equipping the vehicle of claim 7 comprising only the steps of:
i) install said combination adapter in said driver's window, said combination adapter having said access door, said combination adapter consisting of said rigid panel cut slightly larger than said driver's window opening to allow for a water seal to be place around the entire perimeter of said driver's window opening, said combination adapter installed from the outside of vehicle and aligned by 4 levers, one in each corner of said driver's window opening, said levers secured by carriage bolt and wing nut, said levers being spaced away from said rigid panel by 2 inch diameter rod cut to length such that said levers overlap the interior door frame around said driver's window opening and holds said rigid panel firmly against said exterior of said driver's window opening, said access door being hinged at the top edge allowing access for a human hand to reach controls on an external appliance;
j) install the temporary addition of said tub large enough for an adult to sit in, said tub is used for catching bathing waste water;
k) install a plurality of sun shades temporarily attached to the perimeter of said tub to prevent splashing of bathing water outside of said tub, thereby protecting said cargo carrying area floor from water damage;
l) install said support structure, preferably being said folding step stool for reasons of easy and compact storage;
m) install said hot water heater used for bathing on said folding step stool, said hot water heater being placed upon said support structure with appropriate spacer to make said hot water heater controls at the same height as said access door opening on said combination adapter, said hot water heater controls positioned at a horizontal distance no greater than 10 inches from said access door opening; said access door also providing a port for said conduit from said external appliance to deliver hot water to a shower head in said tub for bathing, said tub having a plurality of sun shades temporarily attached to the perimeter of said tub to prevent splashing of bathing water outside of said tub.

9. A method for equipping the vehicle of claim 7 comprising only one step, in an open said louvered window, install said natural ventilation adapter by cutting commercially available flap seal to a length of said louvered window's perimeter less the length of the said louvered window's hinge, then installing said flap seal, said flap seal being held in place by the push-on clamp channel that has a metal spring, said metal spring being removed from last 4 inches of each end of said flap seal, bottom side of said flap seal has ventilation holes, said ventilation holes being covered with screening material.

10. A method for equipping the vehicle of claim 7 comprising only the step of: install said window covers, to provide said total privacy, said total privacy provided by said window covers blocking sight into said vehicle from outside, said window covers being comprised of a semi-rigid core material roughly the size of the inside area of said all windows and said semi-rigid core being covered on the exterior side by an opaque material, said opaque material preferably being larger than said semi-rigid core so as to provide a visual seal around the perimeter of said all window covers, said semi-rigid core material being held against the inside of said all windows by friction fit, said visual seal formed by folding the extra said opaque material to make a half inch lip when said opaque material is stapled to said semi-rigid core material, said window covers could alternately be a single plastic unit that is molded to fit each said all windows, said single plastic unit may also have a seal attached to it.

11. A method for equipping the vehicle of claim 7 comprising only the step of: install said dash-mounted shelf to support cooking or fan appliances, said dash-mounted shelf made of rigid core material cut in a square approximately 30 inches by 30 inches with the front side next to the windshield being cut to match the curve of said windshield, said dash-mounted shelf sides being parallel to said laterally spaced side walls, said dash-mounted shelf is supported in the front by the dash of said vehicle, the rear edge of said dash-mounted shelf is supported by a leg reaching to said horizontal floor portion, said dash-mounted shelf secured from lateral movements by two or more restraining points, said restraining points being implemented with posts that protrude down into the grate provided for defrosting of said windshield.

12. A method of equipping a vehicle especially a newly manufactured vehicle with the functionality that will facilitate said external appliance interface, said privacy, and rain and insect proof ventilation in a manner that is both easier to implement and a more durable design, where said ports for said conduits will not pass through windows or tailgate but will utilize interface panels mounted in the metal body of said vehicle comprising one or more of the steps:
a) install one or more said interface panels mounted on top, rear, bottom, or sides of said new vehicle which will function to couple one or more said air ducts, one or more water connectors, and one or more electrical connectors, to provide portals from the interior to the exterior of said newly manufactured vehicle, said electrical connectors used for electrical power or electrical control signals to support removably installed said external appliances;
b) install window coverings on said all windows that consist of commercially fabricated single piece plastic molded to fit each of said all window in said newly manufactured vehicle;
c) install a natural ventilation adapter on said louvered windows in said vehicle, which would involve replacing the traditional window seal with a water proof material that encloses the entire opening of said louvered windows with said water proof material, water proof material compresses like an accordion material allowing said window to be completely closed, said accordion material being relatively flat when said louvered window is fully open, said water proof material being not porous to prevent rain from entering said vehicle on the top and rear edge of said window, while said water proof material will have openings on the bottom, said openings covered with insect proof said screening material to allow ventilation, said natural ventilation adapter can be attached to said louvered window glass with an adhesive or using a push-on clamp channel, similarly said natural ventilation adapter can be attached to said vehicle metal part around the said louvered window opening with either said adhesive or said push-on clamp channel, resulting in four possible combinations for attachments, the choice is up to the manufacturer, alternately, said rear edge of said natural ventilation adapter can have one or more overlapping said accordion material with said screening material for additional ventilation;
All three steps thereby allowing said louvered windows to remain open during rain and said interface panels providing the ability to duct fresh or conditioned air or liquid from outside said vehicle to inside said vehicle without the use of said tailgate, or said window openings and said adapters for, said tailgate, or said window openings.

13. The vehicle of claim 12 limited to one step: install one or more said interface panels mounted on top, rear, bottom, or sides of said new vehicle which will function to couple one or more said air ducts, one or more water connectors, and one or more electrical connectors, to provide portals from the interior to the exterior of said newly manufactured vehicle, said electrical connectors used for electrical power or electrical control signals to support removably installed said external appliances.

14. The vehicle of claim 12 limited to one step: install a natural ventilation adapter on said louvered windows in said vehicle, which would involve replacing the traditional window seal with a water proof material that encloses the entire opening of said louvered windows with said water proof material, water proof material compresses like an accordion material allowing said window to be completely closed, said accordion material being relatively flat when said louvered window is fully open, said water proof material being not porous to prevent rain from entering said vehicle on the top and rear edge of said window, while said water proof material will have openings on the bottom, said openings covered with insect proof said screening material to allow ventilation, said natural ventilation adapter can be attached to said louvered window glass with an adhesive or using a push-on clamp channel, similarly said natural ventilation adapter can be attached to said vehicle metal part around the said louvered window opening with either said adhesive or said push-on clamp channel, resulting in four possible combinations for attachments, the choice is up to the manufacturer, alternately, said rear edge of said natural ventilation adapter can have one or more overlapping said accordion material with said screening material for additional ventilation.
